(19) United States
(12) Patent Application Publication
(10) Pub. No.: US 2025/0035457 A1
(43) Pub. Date: Jan. 30, 2025

(54) SYSTEMS AND METHODS FOR GENERATING VEHICLE SAFETY SCORES AND PREDICTING VEHICLE COLLISION PROBABILITIES

(71) Applicant: Geotab Inc., Oakville (CA)

(72) Inventors: Xin Zhang, Waterloo (CA); Gregory Gordon Douglas Hines, Mississauga (CA); Jiawei Yu, Aurora (CA); Willem Petersen, Elmira (CA); Tuhin Tiwari, Kitchener (CA); Meenakshi Sundaram Murugesan, Oakville (CA); Javed Siddique, York (CA); Jason Jiajie Yan, Oakville (CA); Narasimha Rao Durgam, Calgary (CA); Li Zhang, Oakville (CA); Vinay Kiran Manjunath, Kitchener (CA); Xinrong Zhou, Toronto (CA); Yujie Chen, Toronto (CA); Chenyue Xu, Richmond Hill (CA); Luis Perez Vazquez, Madrid (ES)

(21) Appl. No.: 18/885,909

(22) Filed: Sep. 16, 2024

Related U.S. Application Data
(63) Continuation-in-part of application No. 18/499,707, filed on Nov. 1, 2023.
(60) Provisional application No. 63/450,844, filed on Mar. 8, 2023.
(60) Provisional application No. 63/425,395, filed on Nov. 15, 2022.

(51) Int. Cl. G01C 21/36; G06N 20/20; H04W 4/029

(52) U.S. Cl. CPC G01C 21/3617; G06N 20/20; H04W 4/029

(57) ABSTRACT

Systems and methods for predicting collision probabilities are provided. The methods involve operating at least one processor to: retrieve vehicle data originating from a telematics device installed in a vehicle, the vehicle data including location data and a plurality of safety exception events performed by the vehicle, the plurality of safety exception events including a plurality of exception event types; identify a plurality of road network edges traveled by the vehicle based on the location data; determine an aggregated area collision rate based on the plurality of road network edges; determine a plurality of exception rates based on the vehicle data, each exception rate representing a normalized rate of occurrence of one of the exception event types; and determine a collision probability using at least one machine learning model on the plurality of exception rates and the aggregated area collision rate, the collision probability representing a risk of collision.

### CROSS-REFERENCE TO RELATED APPLICATIONS

This application is a continuation-in-part of U.S. patent application Ser. No. 18/499,707 filed Nov. 1, 2023 and titled “SYSTEMS AND METHODS FOR GENERATING VEHICLE SAFETY SCORES AND PREDICTING VEHICLE COLLISION PROBABILITIES”, which claims priority to U.S. Provisional Patent Application No. 63/450,844 filed Mar. 8, 2023 and titled “SYSTEMS AND METHODS FOR GENERATING VEHICLE SAFETY SCORES” and U.S. Provisional Patent Application No. 63/425,395 filed Nov. 15, 2022 and titled “Assessing Driver Safety with Enhanced Telematics Data”, the contents of which are incorporated herein by reference for all purposes.

### FIELD

The embodiments described herein generally relate to vehicles, telematics devices, and telematics data, and in particular, to generating vehicle and driver safety scores and predicting vehicle and driver collision probabilities using telematics data.

### BACKGROUND

The following is not an admission that anything discussed below is part of the prior art or part of the common general knowledge of a person skilled in the art.

Traffic accidents, collisions, or crashes involving vehicles can have serious consequences. Crashes can result in serious injury or even death to road users, such as vehicle passengers, cyclists, and pedestrians. Collisions can also result in significant damage to personal property. Hence, reduction in the occurrence and consequences of traffic accidents involving vehicles is desirable.

Most traffic accidents are caused by human error. Consequently, improving driver behaviour can significantly reduce the risk and impact of traffic accidents. Insurance providers, fleet managers, and other stakeholders have attempted to track, evaluate, and improve driver behaviour in various ways. However, it can be difficult to assess or predict the safety risk or performance of a particular driver or vehicle.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In accordance with a broad aspect, there is provided a method for generating vehicle safety scores. The method involves operating at least one processor to: retrieve vehicle data originating from a telematics device installed in a vehicle, the vehicle data including a plurality of safety exception events performed by the vehicle, the plurality of safety exception events including a plurality of exception event types; determine a plurality of exception rates based on the vehicle data, each exception rate representing a normalized rate of occurrence of one of the exception event types; convert the plurality of exception rates into a plurality of exception scores by processing each exception rate using a plurality of statistical transformation functions such that each exception score satisfies a predetermined statistical distribution; and determine a vehicle safety score for the vehicle based on each exception score, the vehicle safety score representing a risk of the vehicle performing a safety exception event.

In some embodiments, the plurality of statistical transformation functions can include a sigmoid transformation function operable to transform each exception rate to satisfy predetermined upper and lower bounds.

In some embodiments, the plurality of statistical transformation functions can include an inverse transformation function operable to transform each exception rate to satisfy a predetermined normal distribution.

In some embodiments, the method can further involve operating the at least one processor to: determine a vehicle safety score benchmark for the vehicle based on the vehicle safety score for the vehicle and a plurality of vehicle safety scores for a plurality of comparable vehicles.

In some embodiments, the method can further involve operating the at least one processor to: identify the plurality of comparable vehicles from a plurality of vehicles by: using a clustering algorithm to identify a plurality of first vehicle clusters based on an area of operation of each vehicle in the plurality of vehicles; and using a comparison algorithm to identify a plurality of second vehicle clusters based on the centroid of each first vehicle cluster; and identify the second vehicle cluster containing the vehicle as the plurality of comparable vehicles.

In some embodiments, the clustering algorithm can identify the plurality of first vehicle clusters further based on a vocation and make and model of each vehicle in the plurality of vehicles.

In some embodiments, the clustering algorithm can be a k-means algorithm.

In some embodiments, the comparison algorithm can be a k-nearest neighbors algorithm.

In some embodiments, the method can further involve operating the at least one processor to: determine a fleet safety score for a fleet including the vehicle based on the vehicle safety score for the vehicle and a vehicle safety score for each other vehicle in the fleet.

In some embodiments, the method can further involve operating the at least one processor to: determine a fleet safety score benchmark for the fleet based on the fleet safety score for the fleet and a plurality of fleet safety scores for a plurality of comparable fleets.

In some embodiments, the method can further involve operating the at least one processor to: identify the plurality of comparable fleets from a plurality of fleets by using a clustering algorithm to identify a plurality of fleet clusters based on a vehicle type of each vehicle in each fleet in the plurality of fleets; and identify the fleet cluster containing the fleet as the plurality of comparable fleets.

In some embodiments, the plurality of exception event types can include harsh events, speeding events, and seatbelt events; the plurality of exception rates can include a harsh event rate, a speeding event rate, and a seatbelt event rate; and the plurality of exception scores can include a harsh event score, a speeding event score, and a seatbelt event score.

In some embodiments, the harsh events can include harsh acceleration events, harsh braking events, and harsh cornering events.

In some embodiments, the harsh events can include harsh event magnitudes and the harsh event rate can include a harsh event magnitude rate.

In some embodiments, the speeding events can include light speeding events, medium speeding events, and heavy speeding events.

In accordance with a broad aspect, there is provided a system for generating vehicle safety scores. The system includes: at least one data store and at least one processor in communication with the at least one data store. The at least one data store is operable to store vehicle data originating from a telematics device installed in a vehicle, the vehicle data including a plurality of safety exception events performed by the vehicle, the plurality of safety exception events including a plurality of exception event types. The at least one processor is operable to: retrieve the vehicle data; determine a plurality of exception rates based on the vehicle data, each exception rate representing a normalized rate of occurrence of one of the exception event types; convert the plurality of exception rates into a plurality of exception scores by processing each exception rate using a plurality of statistical transformation functions such that each exception score satisfies a predetermined statistical distribution; and determine a vehicle safety score for the vehicle based on each exception score, the vehicle safety score representing a risk of the vehicle performing a safety exception event.

In some embodiments, the plurality of statistical transformation functions can include a sigmoid transformation function operable to transform each exception rate to satisfy predetermined upper and lower bounds.

In some embodiments, the plurality of statistical transformation functions can include an inverse transformation function operable to transform each exception rate to satisfy a predetermined normal distribution.

In some embodiments, the at least one processor can be further operable to: determine a vehicle safety score benchmark for the vehicle based on the vehicle safety score for the vehicle and a plurality of vehicle safety scores for a plurality of comparable vehicles.

In some embodiments, the at least one processor can be further operable to: identify the plurality of comparable vehicles from a plurality of vehicles by: using a clustering algorithm to identify a plurality of first vehicle clusters based on an area of operation of each vehicle in the plurality of vehicles; and using a comparison algorithm to identify a plurality of second vehicle clusters based on the centroid of each first vehicle cluster; and identify the second vehicle cluster containing the vehicle as the plurality of comparable vehicles.

In some embodiments, the clustering algorithm can identify the plurality of first vehicle clusters further based on a vocation and make and model of each vehicle in the plurality of vehicles.

In some embodiments, the clustering algorithm can be a k-means algorithm.

In some embodiments, the comparison algorithm can be a k-nearest neighbors algorithm.

In some embodiments, the at least one processor can be further operable to:

determine a fleet safety score for a fleet including the vehicle based on the vehicle safety score for the vehicle and a vehicle safety score for each other vehicle in the fleet.

In some embodiments, the at least one processor can be further operable to: determine a fleet safety score benchmark for the fleet based on the fleet safety score for the fleet and a plurality of fleet safety scores for a plurality of comparable fleets.

In some embodiments, the at least one processor can be further operable to: identify the plurality of comparable fleets from a plurality of fleets by using a clustering algorithm to identify a plurality of fleet clusters based on a vehicle type of each vehicle in each fleet in the plurality of fleets; and identify the fleet cluster containing the fleet as the plurality of comparable fleets.

In some embodiments, the plurality of exception event types can include harsh events, speeding events, and seatbelt events; the plurality of exception rates can include a harsh event rate, a speeding event rate, and a seatbelt event rate; and the plurality of exception scores can include a harsh event score, a speeding event score, and a seatbelt event score.

In some embodiments, the harsh events can include harsh acceleration events, harsh braking events, and harsh cornering events.

In some embodiments, the harsh events can include harsh event magnitudes and the harsh event rate can include a harsh event magnitude rate.

In some embodiments, the speeding events can include light speeding events, medium speeding events, and heavy speeding events.

In accordance with a broad aspect, there is provided a method for generating vehicle collision probability models. The method involves operating at least one processor to: retrieve vehicle data originating from a plurality of telematics devices installed in a plurality of vehicles, the vehicle data including a plurality of safety exception events performed by the plurality of vehicles and a plurality of collision events performed by at least some of the plurality of vehicles, the plurality of safety exception events including a plurality of exception event types; determine a plurality of exception rates based on the vehicle data, each exception rate representing a normalized rate of occurrence of one of the exception event types; determine a plurality of collision rates for each exception event type based on the vehicle data and the plurality of exception rates; and generate a plurality of collision probability models based on the plurality of collision rates and the plurality of exception rates, a collision probability model being generated for each exception event type and operable to predict a collision sub-probability based on an exception rate of the associated exception event type.

In some embodiments, determining the plurality of collision rates for each exception event type can involve: determining a plurality of data buckets for each exception event type based on the plurality of exception rates; and determining a collision rate for each data bucket.

In some embodiments, each data bucket can correspond to a quantile of the exception rates for one of the exception event types.

In some embodiments, generating the plurality of collision probability models can involve: determining a logarithmic function for each exception event type based on the corresponding collision rates and exception rates.

In some embodiments, the plurality of exception event types can include harsh events and speeding events; and the plurality of exception rates can include harsh event rates and speeding event rates.

In some embodiments, the harsh events can include harsh acceleration events, harsh braking events, and harsh cornering events.

In some embodiments, the harsh events can include harsh event magnitudes and the harsh event rates can include harsh event magnitude rates.

In some embodiments, the speeding events can include light speeding events, medium speeding events, and heavy speeding events.

In accordance with a broad aspect, there is provided a system for generating vehicle collision probability models. The system includes: at least one data store and at least one processor in communication with the at least one data store. The at least one data store is operable to store vehicle data originating from a telematics device installed in a vehicle, the vehicle data including a plurality of safety exception events performed by the vehicle, the plurality of safety exception events including a plurality of exception event types. The at least one processor is operable to: retrieve the vehicle data; determine a plurality of exception rates based on the vehicle data, each exception rate representing a normalized rate of occurrence of one of the exception event types; determine plurality of collision sub-probabilities using a plurality of collision probability models and the plurality of exception rates, each collision probability model associated with one of the exception event types and operable to predict one of the collision sub-probabilities based on one of the exception rates of the associated exception event type; and determine a collision probability for the vehicle based on the plurality of collision sub-probabilities, the collision probability representing a risk of collision for the vehicle.

In some embodiments, determining the plurality of collision rates for each exception event type can involve: determining a plurality of data buckets for each exception event type based on the plurality of exception rates; and determining a collision rate for each data bucket.

In some embodiments, each data bucket can correspond to a quantile of the exception rates for one of the exception event types.

In some embodiments, generating the plurality of collision probability models can involve: determining a logarithmic function for each exception event type based on the corresponding collision rates and exception rates.

In some embodiments, the plurality of exception event types can include harsh events and speeding events; and the plurality of exception rates can include harsh event rates and speeding event rates.

In some embodiments, the harsh events can include harsh acceleration events, harsh braking events, and harsh cornering events.

In some embodiments, the harsh events can include harsh event magnitudes and the harsh event rates can include harsh event magnitude rates.

In some embodiments, the speeding events can include light speeding events, medium speeding events, and heavy speeding events.

In accordance with a broad aspect, there is provided a method for predicting vehicle collision probabilities. The method involves operating at least one processor to: retrieve vehicle data originating from a telematics device installed in a vehicle, the vehicle data including a plurality of safety exception events performed by the vehicle, the plurality of safety exception events including a plurality of exception event types; determine a plurality of exception rates based on the vehicle data, each exception rate representing a normalized rate of occurrence of one of the exception event types; determine plurality of collision sub-probabilities using a plurality of collision probability models and the plurality of exception rates, each collision probability model associated with one of the exception event types and operable to predict one of the collision sub-probabilities based on one of the exception rates of the associated exception event type; and determine a collision probability for the vehicle based on the plurality of collision sub-probabilities, the collision probability representing a risk of collision for the vehicle.

In some embodiments, determining the collision probability of the vehicle can involve: determining a vehicle class of the vehicle; and scaling the collision probability based on the vehicle class of the vehicle.

In some embodiments, determining the collision probability of the vehicle can involve: applying a predetermined weight to each collision sub-probability.

In some embodiments, the collision probability of the vehicle can be a predicted number of collisions for a predetermined travel distance.

In some embodiments, the collision probability of the vehicle can be a predicted likelihood of a collision for a predetermined travel distance.

In some embodiments, the method can further involve operating the at least one processor to: determine a vehicle collision probability benchmark for the vehicle based on the collision probability score for the vehicle and a plurality of collision probabilities for a plurality of comparable vehicles.

In some embodiments, the method can further involve operating the at least one processor to: identify the plurality of comparable vehicles from a plurality of vehicles by: using a clustering algorithm to identify a plurality of first vehicle clusters based on an area of operation of each vehicle in the plurality of vehicles; and using a comparison algorithm to identify a plurality of second vehicle clusters based on the centroid of each first vehicle cluster; and identify the second vehicle cluster containing the vehicle as the plurality of comparable vehicles.

In some embodiments, the clustering algorithm can identify the plurality of first vehicle clusters further based on a vocation and make and model of each vehicle in the plurality of vehicles.

In some embodiments, the clustering algorithm can be a k-means algorithm.

In some embodiments, the comparison algorithm can be a k-nearest neighbors algorithm.

In some embodiments, the method can further involve operating the at least one processor to: determine a fleet collision probability for a fleet including the vehicle based on the vehicle collision probability for the vehicle and a vehicle collision probability for each other vehicle in the fleet.

In some embodiments, the method can further involve operating the at least one processor to: determine a fleet collision probability benchmark for the fleet based on the fleet collision probability for the fleet and a plurality of fleet collision probabilities for a plurality of comparable fleets.

In some embodiments, the method can further involve operating the at least one processor to: identify the plurality of comparable fleets from a plurality of fleets by using a clustering algorithm to identify a plurality of fleet clusters based on a vehicle type of each vehicle in each fleet in the plurality of fleets; and identify the fleet cluster containing the fleet as the plurality of comparable fleets.

In some embodiments, the plurality of exception event types can include harsh events and speeding events; and the plurality of exception rates can include harsh event rates and speeding event rates.

In some embodiments, the harsh events can include harsh acceleration events, harsh braking events, and harsh cornering events.

In some embodiments, the harsh events can include harsh event magnitudes and the harsh event rates can include harsh event magnitude rates.

In some embodiments, the speeding events can include light speeding events, medium speeding events, and heavy speeding events.

In accordance with a broad aspect, there is provided a system for predicting vehicle collision probabilities. The system includes: at least one data store and at least one processor in communication with the at least one data store. The at least one data store is operable to store vehicle data originating from a telematics device installed in a vehicle, the vehicle data including a plurality of safety exception events performed by the vehicle, the plurality of safety exception events including a plurality of exception event types. The at least one processor is operable to: retrieve the vehicle data; determine a plurality of exception rates based on the vehicle data, each exception rate representing a normalized rate of occurrence of one of the exception event types; determine plurality of collision sub-probabilities using a plurality of collision probability models and the plurality of exception rates, each collision probability model associated with one of the exception event types and operable to predict one of the collision sub-probabilities based on one of the exception rates of the associated exception event type; and determine a collision probability for the vehicle based on the plurality of collision sub-probabilities, the collision probability representing a risk of collision for the vehicle.

In some embodiments, determining the collision probability of the vehicle can involve: determining a vehicle class of the vehicle; and scaling the collision probability based on the vehicle class of the vehicle.

In some embodiments, determining the collision probability of the vehicle can involve: applying a predetermined weight to each collision sub-probability.

In some embodiments, the collision probability of the vehicle can be a predicted number of collisions for a predetermined travel distance.

In some embodiments, the collision probability of the vehicle can be a predicted likelihood of a collision for a predetermined travel distance.

In some embodiments, the at least one processor can be operable to: determine a vehicle collision probability benchmark for the vehicle based on the collision probability score for the vehicle and a plurality of collision probabilities for a plurality of comparable vehicles.

In some embodiments, the at least one processor can be operable to: identify the plurality of comparable vehicles from a plurality of vehicles by: using a clustering algorithm to identify a plurality of first vehicle clusters based on an area of operation of each vehicle in the plurality of vehicles; and using a comparison algorithm to identify a plurality of second vehicle clusters based on the centroid of each first vehicle cluster; and identify the second vehicle cluster containing the vehicle as the plurality of comparable vehicles.

In some embodiments, the clustering algorithm can identify the plurality of first vehicle clusters further based on a vocation and make and model of each vehicle in the plurality of vehicles.

In some embodiments, the clustering algorithm can be a k-means algorithm.

In some embodiments, the comparison algorithm can be a k-nearest neighbors algorithm.

In some embodiments, the at least one processor can be operable to: determine a fleet collision probability for a fleet including the vehicle based on the vehicle collision probability for the vehicle and a vehicle collision probability for each other vehicle in the fleet.

In some embodiments, the at least one processor can be operable to: determine a fleet collision probability benchmark for the fleet based on the fleet collision probability for the fleet and a plurality of fleet collision probabilities for a plurality of comparable fleets.

In some embodiments, the at least one processor can be operable to: identify the plurality of comparable fleets from a plurality of fleets by using a clustering algorithm to identify a plurality of fleet clusters based on a vehicle type of each vehicle in each fleet in the plurality of fleets; and identify the fleet cluster containing the fleet as the plurality of comparable fleets.

In some embodiments, the plurality of exception event types can include harsh events and speeding events; and the plurality of exception rates can include harsh event rates and speeding event rates.

In some embodiments, the harsh events can include harsh acceleration events, harsh braking events, and harsh cornering events.

In some embodiments, the harsh events can include harsh event magnitudes and the harsh event rates can include harsh event magnitude rates.

In some embodiments, the speeding events can include light speeding events, medium speeding events, and heavy speeding events.

In accordance with a broad aspect, there is provided a method for predicting vehicle collision probabilities. The method involves operating at least one processor to: retrieve first vehicle data originating from a plurality of telematics devices installed in a plurality of vehicles, the first vehicle data including a plurality of first safety exception events performed by the plurality of vehicles and a plurality of collision events performed by at least some of the plurality of vehicles, the plurality of first safety exception events including a plurality of exception event types; determine a plurality of first exception rates based on the first vehicle data, each first exception rate representing a normalized rate of occurrence of one of the exception event types; determine a plurality of collision rates for each exception event type based on the first vehicle data and the plurality of first exception rates; generate a plurality of collision probability models based on the plurality of collision rates and the plurality of first exception rates, a collision probability model being generated for each exception event type and operable to predict a collision sub-probability based on an exception rate of the associated exception event type; retrieve second vehicle data originating from a telematics device installed in a vehicle, the second vehicle data including a plurality of second safety exception events performed by the vehicle, the plurality of second safety exception events including at least some of the plurality of exception event types; determine a plurality of second exception rates based on the second vehicle data, each second exception rate representing a normalized rate of occurrence of one of the exception event types; determine plurality of collision sub-probabilities using the plurality of collision probability models and the plurality of second exception rates; and determine a collision probability for the vehicle based on the plurality of collision sub-probabilities, the collision probability representing a risk of collision for the vehicle.

In some embodiments, determining the plurality of collision rates for each exception event type can involve: determining a plurality of data buckets for each exception event type based on the plurality of exception rates; and determine a collision rate for each data bucket.

In some embodiments, each data bucket can correspond to a quantile of the exception rates for one of the exception event types.

In some embodiments, generating the plurality of collision probability models can involve: determining a logarithmic function for each exception event type based on the corresponding collision rates and first exception rates.

In some embodiments, determining the collision probability of the vehicle can involve: determining a vehicle class of the vehicle; and scaling the collision probability based on the vehicle class of the vehicle.

In some embodiments, determining the collision probability of the vehicle can involve: applying a predetermined weight to each collision sub-probability.

In some embodiments, the collision probability of the vehicle can be a predicted number of collisions for a predetermined travel distance.

In some embodiments, the collision probability of the vehicle can be a predicted likelihood of a collision for a predetermined travel distance.

In some embodiments, the method can further involve operating the at least one processor to: determine a vehicle collision probability benchmark for the vehicle based on the collision probability score for the vehicle and a plurality of collision probabilities for a plurality of comparable vehicles.

In some embodiments, the method can further involve operating the at least one processor to: identify the plurality of comparable vehicles from a plurality of third vehicles by: using a clustering algorithm to identify a plurality of first vehicle clusters based on an area of operation of each vehicle in the plurality of third vehicles; and using a comparison algorithm to identify a plurality of second vehicle clusters based on the centroid of each first vehicle cluster; and identify the second vehicle cluster containing the vehicle as the plurality of comparable vehicles.

In some embodiments, the clustering algorithm can identify the plurality of first vehicle clusters further based on a vocation and make and model of each vehicle in the plurality of third vehicles.

In some embodiments, the clustering algorithm can be a k-means algorithm.

In some embodiments, the comparison algorithm can be a k-nearest neighbors algorithm.

In some embodiments, the method can further involve operating the at least one processor to: determine a fleet collision probability for a fleet including the vehicle based on the vehicle collision probability for the vehicle and a vehicle collision probability for each other vehicle in the fleet.

In some embodiments, the method can further involve operating the at least one processor to: determine a fleet collision probability benchmark for the fleet based on the fleet collision probability for the fleet and a plurality of fleet collision probabilities for a plurality of comparable fleets.

In some embodiments, the method can further involve operating the at least one processor to: identify the plurality of comparable fleets from a plurality of fleets by using a clustering algorithm to identify a plurality of fleet clusters based on a vehicle type of each vehicle in each fleet in the plurality of fleets; and identify the fleet cluster containing the fleet as the plurality of comparable fleets.

In some embodiments, the plurality of exception event types can include harsh events and speeding events; and the plurality of first and second exception rates can include harsh event rates and speeding event rates.

In some embodiments, the harsh events can include harsh acceleration events, harsh braking events, and harsh cornering events.

In some embodiments, the harsh events can include harsh event magnitudes and the harsh event rates can include harsh event magnitude rates.

In some embodiments, the speeding events can include light speeding events, medium speeding events, and heavy speeding events.

In accordance with a broad aspect, there is provided a system for predicting vehicle collision probabilities. The system includes at least one data store and at least one processor in communication with the at least one data store. The at least one data store is operable to store first vehicle data and second vehicle data, the first vehicle data originating from a plurality of telematics devices installed in a plurality of vehicles, the first vehicle data including a plurality of first safety exception events performed by the plurality of vehicles and a plurality of collision events performed by at least some of the plurality of vehicles, the plurality of first safety exception events including a plurality of exception event types, the second vehicle data originating from a telematics device installed in a vehicle, the second vehicle data including a plurality of second safety exception events performed by the vehicle, the plurality of second safety exception events including at least some of the plurality of exception event types. The at least one processor is operable to: retrieve the first vehicle data; determine a plurality of first exception rates based on the first vehicle data, each first exception rate representing a normalized rate of occurrence of one of the exception event types; determine a plurality of collision rates for each exception event type based on the first vehicle data and the plurality of first exception rates; generate a plurality of collision probability models based on the plurality of collision rates and the plurality of first exception rates, a collision probability model being generated for each exception event type and operable to predict a collision sub-probability based on an exception rate of the associated exception event type; retrieve the second vehicle data; determine a plurality of second exception rates based on the second vehicle data, each second exception rate representing a normalized rate of occurrence of one of the exception event types; determine plurality of collision sub-probabilities using the plurality of collision probability models and the plurality of second exception rates; and determine a collision probability for the vehicle based on the plurality of collision sub-probabilities, the collision probability representing a risk of collision for the vehicle.

In some embodiments, determining the plurality of collision rates for each exception event type can involve: determining a plurality of data buckets for each exception event type based on the plurality of exception rates; and determining a collision rate for each data bucket.

In some embodiments, each data bucket can correspond to a quantile of the exception rates for one of the exception event types.

In some embodiments, generating the plurality of collision probability models can involve: determining a logarithmic function for each exception event type based on the corresponding collision rates and first exception rates.

In some embodiments, determining the collision probability of the vehicle can involve: determining a vehicle class of the vehicle; and scaling the collision probability based on the vehicle class of the vehicle.

In some embodiments, determining the collision probability of the vehicle can involve: applying a predetermined weight to each collision sub-probability.

In some embodiments, the collision probability of the vehicle can be a predicted number of collisions for a predetermined travel distance.

In some embodiments, the collision probability of the vehicle can be a predicted likelihood of a collision for a predetermined travel distance.

In some embodiments, the at least one processor can be operable to: determine a vehicle collision probability benchmark for the vehicle based on the collision probability score for the vehicle and a plurality of collision probabilities for a plurality of comparable vehicles.

In some embodiments, the at least one processor can be operable to: identify the plurality of comparable vehicles from a plurality of third vehicles by: using a clustering algorithm to identify a plurality of first vehicle clusters based on an area of operation of each vehicle in the plurality of third vehicles; and using a comparison algorithm to identify a plurality of second vehicle clusters based on the centroid of each first vehicle cluster; and identify the second vehicle cluster containing the vehicle as the plurality of comparable vehicles.

In some embodiments, the clustering algorithm can identify the plurality of first vehicle clusters further based on a vocation and make and model of each vehicle in the plurality of third vehicles.

In some embodiments, the clustering algorithm can be a k-means algorithm.

In some embodiments, the comparison algorithm can be a k-nearest neighbors algorithm.

In some embodiments, the at least one processor can be operable to: determine a fleet collision probability for a fleet including the vehicle based on the vehicle collision probability for the vehicle and a vehicle collision probability for each other vehicle in the fleet.

In some embodiments, the at least one processor can be operable to: determine a fleet collision probability benchmark for the fleet based on the fleet collision probability for the fleet and a plurality of fleet collision probabilities for a plurality of comparable fleets.

In some embodiments, the at least one processor can be operable to: identify the plurality of comparable fleets from a plurality of fleets by using a clustering algorithm to identify a plurality of fleet clusters based on a vehicle type of each vehicle in each fleet in the plurality of fleets; and identify the fleet cluster containing the fleet as the plurality of comparable fleets.

In some embodiments, the plurality of exception event types can include harsh events and speeding events; and the plurality of first and second exception rates can include harsh event rates and speeding event rates.

In some embodiments, the harsh events can include harsh acceleration events, harsh braking events, and harsh cornering events.

In some embodiments, the harsh events can include harsh event magnitudes and the harsh event rates can include harsh event magnitude rates.

In some embodiments, the speeding events can include light speeding events, medium speeding events, and heavy speeding events.

In accordance with a broad aspect, there is a system for predicting collision probabilities. The includes at least one data store and at least one processor in communication with the at least one data store. The at least one data store is operable to store vehicle data originating from a telematics device installed in a vehicle. The vehicle data includes location data and a plurality of safety exception events performed by the vehicle, the plurality of safety exception events including a plurality of exception event types. The at least one processor is operable to: retrieve the vehicle data; identify a plurality of road network edges traveled by the vehicle based on the location data; determine an aggregated area collision rate based on the plurality of road network edges; determine a plurality of exception rates based on the vehicle data, each exception rate representing a normalized rate of occurrence of one of the exception event types; and determine a collision probability using at least one machine learning model on the plurality of exception rates and the aggregated area collision rate, the collision probability representing a risk of collision.

In some embodiments, the at least one machine learning model can include a decision tree.

In some embodiments, the at least one processor can be operable to: retrieve a plurality of predetermined area collision rates, a predetermined area collision rate retrieved for each road network edge; and determine the aggregated area collision rate based on the plurality of predetermined area collision rates.

In some embodiments, at least one processor can be operable to: determine a vehicle collision probability benchmark for the vehicle based on the collision probability and a plurality of collision probabilities for a plurality of comparable vehicles.

In some embodiments, the at least one processor can be operable to: identify the plurality of comparable vehicles from a plurality of vehicles by: using a clustering algorithm to identify a plurality of first vehicle clusters based on an area of operation of each vehicle in the plurality of vehicles; and using a comparison algorithm to identify a plurality of second vehicle clusters based on the centroid of each first vehicle cluster; and identify the second vehicle cluster containing the vehicle as the plurality of comparable vehicles.

In some embodiments, the at least one processor can be operable to: determine a fleet collision probability for a fleet including the vehicle based on the collision probability and a vehicle collision probability for each other vehicle in the fleet.

In some embodiments, the at least one processor can be operable to: determine a fleet collision probability benchmark for the fleet based on the fleet collision probability for the fleet and a plurality of fleet collision probabilities for a plurality of comparable fleets. In some embodiments, the at least one processor can be operable to: identify the plurality of comparable fleets from a plurality of fleets by using a clustering algorithm to identify a plurality of fleet clusters based on a vehicle type of each vehicle in each fleet in the plurality of fleets; and identify the fleet cluster containing the fleet as the plurality of comparable fleets.

In some embodiments, the plurality of exception event types can include harsh events and speeding events; and the plurality of exception rates can include harsh event rates and speeding event rates.

In accordance with a broad aspect, there is a method for predicting collision probabilities. The method involves operating at least one processor to: retrieve vehicle data originating from a telematics device installed in a vehicle, the vehicle data including location data and a plurality of safety exception events performed by the vehicle, the plurality of safety exception events including a plurality of exception event types; identify a plurality of road network edges traveled by the vehicle based on the location data; determine an aggregated area collision rate based on the plurality of road network edges; determine a plurality of exception rates based on the vehicle data, each exception rate representing a normalized rate of occurrence of one of the exception event types; and determine a collision probability using at least one machine learning model on the plurality of exception rates and the aggregated area collision rate, the collision probability representing a risk of collision.

In some embodiments, the at least one machine learning model can include a decision tree.

In some embodiments, the method can further involve operating the at least one processor to: retrieve a plurality of predetermined area collision rates, a predetermined area collision rate retrieved for each road network edge; and determine the aggregated area collision rate based on the plurality of predetermined area collision rates.

In some embodiments, the method can further involve operating the at least one processor to: determine a vehicle collision probability benchmark for the vehicle based on the collision probability and a plurality of collision probabilities for a plurality of comparable vehicles.

In some embodiments, the can method further involve operating the at least one processor to: identify the plurality of comparable vehicles from a plurality of vehicles by: using a clustering algorithm to identify a plurality of first vehicle clusters based on an area of operation of each vehicle in the plurality of vehicles; and using a comparison algorithm to identify a plurality of second vehicle clusters based on the centroid of each first vehicle cluster; and identify the second vehicle cluster containing the vehicle as the plurality of comparable vehicles.

In some embodiments, the method can further involve operating the at least one processor to: determine a fleet collision probability for a fleet including the vehicle based on the collision probability and a vehicle collision probability for each other vehicle in the fleet.

In some embodiments, the method can further involve operating the at least one processor to: determine a fleet collision probability benchmark for the fleet based on the fleet collision probability for the fleet and a plurality of fleet collision probabilities for a plurality of comparable fleets.

In some embodiments, the method can further involve operating the at least one processor to: identify the plurality of comparable fleets from a plurality of fleets by using a clustering algorithm to identify a plurality of fleet clusters based on a vehicle type of each vehicle in each fleet in the plurality of fleets; and identify the fleet cluster containing the fleet as the plurality of comparable fleets.

In some embodiments, the plurality of exception event types can include harsh events and speeding events; and the plurality of exception rates can include harsh event rates and speeding event rates.

In accordance with a broad aspect, there is provided a non-transitory computer readable medium having instructions stored thereon executable by at least one processor to implement any one of the methods herein.

### BRIEF DESCRIPTION OF THE DRAWINGS

Several embodiments will be described in detail with reference to the drawings, in which:

FIG. 1 is a block diagram of various components interacting with an example fleet management system, in accordance with an embodiment;

FIG. 2 is a block diagram of an example fleet management system interacting with an example telematics device and example vehicle, in accordance with an embodiment;

FIG. 3 is a block diagram of an example computing device interacting with an example fleet management system, in accordance with an embodiment;

FIG. 4 is a flowchart of an example method for generating vehicle safety scores, in accordance with an embodiment;

FIG. 5 is a histogram of an example exception rate distribution, in accordance with an embodiment;

FIG. 6 is a histogram of an example exception score distribution, in accordance with an embodiment;

FIG. 7 is a graph of an example sigmoid transformation function, in accordance with an embodiment;

FIG. 8 is a graph of an example inverse transformation function, in accordance with an embodiment;

FIG. 9 is a flowchart of an example implementation of the safety score method shown in FIG. 4, in accordance with an embodiment;

FIG. 10 is a flowchart of an example method for generating vehicle collision probability models, in accordance with an embodiment;

FIG. 11 is a flowchart of an example implementation of a portion of the collision probability model training method shown in FIG. 10, in accordance with an embodiment;

FIG. 12 is a flowchart of an example implementation of a portion of the collision probability model training method shown in FIG. 10, in accordance with an embodiment;

FIG. 13 is a graph of an example collision probability model, in accordance with an embodiment;

FIG. 14 is a flowchart of an example method for predicting vehicle collision probabilities, in accordance with an embodiment;

FIG. 15 is a flowchart of an example implementation of the collision probability methods shown in FIGS. 10 and 14, in accordance with an embodiment;

FIG. 16 is a flowchart of an example method for generating collision probability models, in accordance with an embodiment;

FIG. 17 is an example road network map, in accordance with an embodiment;

FIG. 18 is an example decision tree, in accordance with an embodiment;

FIG. 19 is an example gradient boosted decision tree, in accordance with an embodiment;

FIG. 21 is a flowchart of an example method for predicting collision probabilities, in accordance with an embodiment;

FIG. 22 is a flowchart of an example implementation of the collision probability methods shown in FIGS. 16 and 22, in accordance with an embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DETAILED DESCRIPTION

Various systems or methods will be described below to provide an example of an embodiment of the claimed subject matter. No embodiment described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an embodiment that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

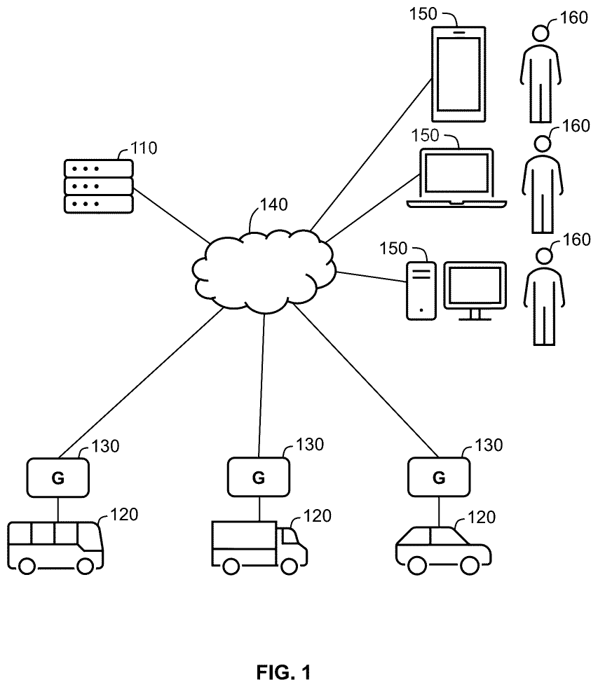

Referring to FIG. 1, there is shown an example asset management system 110 for managing a plurality of assets equipped with a plurality of telematics devices 130. In operation, the telematics devices 130 can gather various data associated with the assets (i.e., telematics data) and share the telematics data with the asset management system 110. The asset management system 110 can be remotely located from the telematics devices 130 and the assets.

For ease of exposition, various examples will now be described in which the assets are vehicles 120 and the asset management system 110 is referred to as a fleet management system 110. However, it should be appreciated that the systems and methods described herein may be used to manage other forms of assets in some embodiments. Such assets can generally include any apparatuses, articles, machines, and/or equipment that can be equipped and monitored by the telematics devices 130. For example, other assets may include shipping containers, trailers, construction equipment, generators, and the like. The nature and format of the telematics data may vary depending on the type of asset.

The vehicles 120 may include any machines for transporting goods or people. The vehicles 120 can include motor vehicles, such as, but not limited to, motorcycles, cars, trucks, and/or buses. The motor vehicles can be gas, diesel, electric, hybrid, and/or alternative fuel. In some cases, the vehicles 120 may include other kinds of vehicles, such as, but not limited to, railed vehicles (e.g., trains, trams), watercraft (e.g., ships, boats), aircraft (e.g., airplanes, helicopters), and/or spacecraft. Each vehicle 120 can be equipped with a telematics device 130. Although only three vehicles 120 having three telematics devices 130 are shown in the illustrated example for ease of illustration, it should be appreciated that there can be any number of vehicles 120 and telematics devices 130. In some cases, the fleet management system 110 may manage hundreds, thousands, or even millions of vehicles 120 and telematics devices 130.

The telematics devices 130 can be standalone devices that are removably installed in the vehicles 120, such as, but not limited to, vehicle tracking devices. Alternatively, the telematics devices 130 can be integrated or embedded components that are integral with the vehicles 120, such as, but not limited to, telematic control units (TCUs). The telematics devices 130 can gather various telematics data from the vehicles 120 and share the telematics data with the fleet management system 110. The telematics data may include any information, parameters, attributes, characteristics, and/or features associated with the vehicles 120. For example, the telematics data can include, but is not limited to, location data, speed data, acceleration data, engine data, brake data, transmission data, fluid data (e.g., oil, coolant, and/or washer fluid), energy data (e.g., battery and/or fuel level), odometer data, vehicle identifying data, error/diagnostic data, tire pressure data, seatbelt data, and/or airbag data. In some cases, the telematics data may include information related to the telematics devices 130 and/or other devices associated with the telematics devices 130.

The fleet management system 110 can process the telematics data collected from the telematics devices 130 to provide various analysis, predictions, and reporting. For example, the fleet management system 110 can process the telematics data to gain additional information regarding the vehicles 120, such as, but not limited to, trip distances/times, idling times, harsh braking/driving, usage rate, and/or fuel economy. Various data analytics and machine learning techniques may be used by the fleet management system 110 to process the telematics data. The telematics data can then be used to manage various aspects of the vehicles 120, such as, but not limited to, route planning, vehicle maintenance, driver compliance, asset utilization, and/or fuel management. In this manner, the fleet management system 110 can improve the productivity, efficiency, safety, and/or sustainability of the vehicles 120.

A plurality of computing devices 150 can provide access to the fleet management system 110 to a plurality of users 160. This may allow the users 160 to manage and track the vehicles 120, for example, using various telematics data collected and/or processed by the fleet management system 110. The computing devices 150 can be any computers, such as, but not limited to, personal computers, portable computers, wearable computers, workstations, desktops, laptops, smartphones, tablets, smartwatches, PDAs (personal digital assistants), and/or mobile devices. The computing devices 150 can be remotely located from the fleet management system 110, telematics devices 130, and vehicles 120. Although only three computing devices 150 operated by three users 160 are shown in the illustrated example for ease of illustration, it should be appreciated that there can be any number of computing devices 150 and users 160. In some cases, the fleet management system 110 may service hundreds, thousands, or even millions of computing devices 150 and users 160.

The fleet management system 110, telematics devices 130, and computing devices 150 can communicate through one or more networks 140. The networks 140 may be wireless, wired, or a combination thereof. The networks 140 may employ any communication protocol and utilize any communication medium. For example, the networks 140 may include, but is not limited to, Wi-Fi™ networks, Ethernet networks, Bluetooth™ networks, NFC (near-field communication) networks, radio networks, cellular networks, and/or satellite networks. The networks 140 may be private, public, or a combination thereof. For example, the networks 140 may include, but is not limited to, LANs (local area networks), WANs (wide area networks), and/or the Internet. The networks 140 may also facilitate communication with other devices and systems that are not shown.

The fleet management system 110 can be implemented using one or more computers. For example, the fleet management system 110 may be implemented using one or more computer servers. The servers can be distributed across a wide geographical area. In some embodiments, the fleet management system 110 may be implemented using a cloud computing platform, such as Google Cloud Platform™ or Amazon Web Services™. In other embodiments, the fleet management system 110 may be implemented using one or more dedicated computer servers.

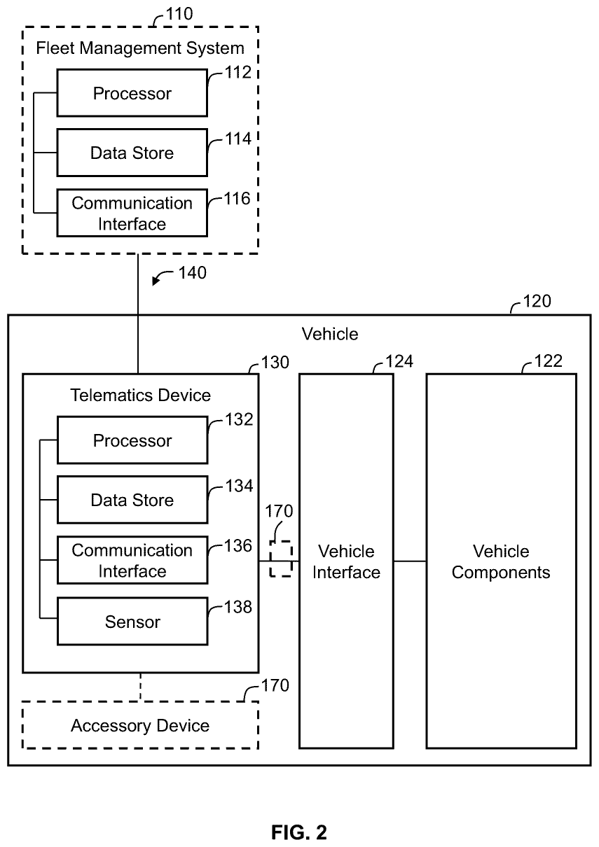

Reference will now be made to FIG. 2 to further explain the operation of the fleet management system 110, telematics devices 130, and vehicles 120. In the illustrated example, the fleet management system 110 in communication with a telematics device 130 that is installed in a vehicle 120.

As shown, the fleet management system 110 can include one or more processors 112, one or more data stores 114, and one or more communication interfaces 116. Each of these components may communicate with each other. Each of these components may be combined into fewer components or divided into additional subcomponents. Two or more of these components and/or subcomponents may be distributed across a wide geographical area.

The processors 112 can control the operation of the fleet management system 110. The processors 112 can be implemented using any suitable processing devices or systems, such as, but not limited to, CPUs (central processing units), GPUs (graphics processing units), FPGAs, (field programmable gate arrays), ASICs (application specific integrated circuits), DSPs (digital signal processors), NPUs (neural processing units), QPUs (quantum processing units), microprocessors, and/or controllers. The processors 112 can execute various computer instructions, programs, and/or software stored on the data stores 114 to implement various methods described herein. For example, the processors 112 may process various telematics data collected by the fleet management system 110 from the telematics device 130.

The data stores 114 can store various data for the fleet management system 110. The data stores 114 can be implemented using any suitable data storage devices or systems, such as, but not limited to, RAM (random access memory), ROM (read only memory), flash memory, HDD (hard disk drives), SSD (solid-state drives), magnetic tape drives, optical disc drives, and/or memory cards. The data stores 114 may include volatile memory, non-volatile memory, or a combination thereof. The data stores 114 may include non-transitory computer readable media. The data stores 114 can store various computer instructions, programs, and/or software that can be executed by the processors 112 to implement various methods described herein. The data stores 114 may store various telematics data collected from the telematics device 130 and/or processed by the processors 112.

The communication interfaces 116 can enable communication between the fleet management system 110 and other devices or systems, such as the telematics device 130. The communication interfaces 116 can be implemented using any suitable communication devices or systems. For example, the communication interfaces 116 may include various physical connectors, ports, or terminals, such as, but not limited to, USB (universal serial bus), Ethernet, Thunderbolt, Firewire, SATA (serial advanced technology attachment), PCI (peripheral component interconnect), HDMI (high-definition multimedia interface), and/or DisplayPort. The communication interfaces 116 can also include various wireless interface components to connect to wireless networks, such as, but not limited to, Wi-Fi™, Bluetooth™, NFC, cellular, and/or satellite. The communication interfaces 116 can enable various inputs and outputs to be received at and sent from the fleet management system 110. For example, the communication interfaces 116 may be used to retrieve telematics data from the telematics device 130.

As shown, the telematics device 130 also can include one or more processors 132, one or more data stores 134, and one or more communication interfaces 136. Additionally, the telematics device 130 can include one or more sensors 138. Each of these components may communicate with each other. Each of these components may be combined into fewer components or divided into additional subcomponents.

The processors 132 can control the operation of the telematics device 130. Like the processors 112 of the fleet management system 110, the processors 132 of the telematics device 130 can be implemented using any suitable processing devices or systems. The processors 132 can execute various computer instructions, programs, and/or software stored on the data stores 134. For example, the processors 132 can process various telematics data gathered from the vehicle components 122 or the sensors 138.

The data stores 134 can store various data for the telematics device 130. Like the data stores 114 of the fleet management system 110, the data stores 134 of the telematics device 130 can be implemented using any suitable data storage devices or systems. The data stores 134 can store various computer instructions, programs, and/or software that can be executed by the processors 132. The data stores 134 can also store various telematics data gathered from the vehicle components 122 or the sensors 138.

The communication interfaces 136 can enable communication between the telematics device 130 and other devices or systems, such as the fleet management system 110 and vehicle components 122. Like the communication interfaces 116 of the fleet management system 110, the communication interfaces 136 of the telematics device 130 can be implemented using any suitable communication devices or systems. The communication interfaces 136 can enable various inputs and outputs to be received at and sent from the telematics device 130. For example, the communication interfaces 136 may be used collect telematics data from the vehicle components 122 and sensors 138 or to send telematics data to the fleet management system 110. The communication interfaces 136 can also be used to connect the telematics device 130 with one or more accessory devices 170.

The sensors 138 can detect and/or measure various environmental events and/or changes. The sensors 138 can include any suitable sensing devices or systems, including, but not limited to, location sensors, velocity sensors, acceleration sensors, orientation sensors, vibration sensors, proximity sensors, temperature sensors, humidity sensors, pressure sensors, optical sensors, and/or audio sensors. When the telematics device 130 is installed in the vehicle 120, the sensor 138 can be used to gather telematics data that may not be obtainable from the vehicle components 122. For example, the sensors 138 may include a satellite navigation device, such as, but not limited to, a GPS (global positioning system) receiver, which can measure the location of the vehicle 120. As another example, the sensor 138 may include accelerometers, gyroscopes, magnetometers, and/or IMUs (inertial measurement units), which can measure the acceleration and/or orientation of the vehicle 120.

In some cases, the telematics device 130 may operate in conjunction with one or more accessory devices 170 that are in communication with the telematics device 130. The accessory devices 170 can include expansion devices that can provide additional functionality to the telematics device 130. For example, the accessory devices 170 may provide additional processing, storage, communication, and/or sensing functionality through one or more additional processors, data storages, communication interfaces, and/or sensors (not shown). The accessory devices 170 can also include adapter devices that facilitate communication between the communication interface 136 and the vehicle interfaces 124, such as a cable harness.

The telematics device 130 can be installed within the vehicle 120, removably or integrally. One or more accessory devices 170 can also be installed in the vehicle 120 along with the telematics device 130. As shown, the vehicle 120 can include one or more vehicle components 122 and one or more vehicle interfaces 124. Each of these components may be combined into fewer components or divided into additional subcomponents.

The vehicle components 122 can include any subsystems, parts, and/or subcomponents of the vehicle 120. The vehicle components 122 can be used to operate and/or control the vehicle 120. For example, the vehicle components 122 can include, but are not limited to, powertrains, engines, transmissions, steering, braking, seating, batteries, doors, and/or suspensions. The telematics device 130 can gather various telematics data from the vehicle components 122. For example, the telematics device 130 may communicate with one or more ECUs (electronic control units) that control the vehicle components 122 and/or one or more internal vehicle sensors.

The vehicle interfaces 124 can facilitate communication between the vehicle components 122 and other devices or systems. The vehicle interfaces 124 can include any suitable communication devices or systems. For example, the vehicle interfaces 124 may include, but is not limited to, ODB-II (on-board diagnostics) ports and/or CAN (controller area network) buses. The vehicle interfaces 124 can be used by the telematics device 130 to gather telematics data from the vehicle components 122. For example, the communication interfaces 136 of the telematics device 130 can be connected to the vehicle interfaces 124 to communicate with the vehicle components 122. In some cases, an accessory device 170, such as a wire harness, can provide the connection between the communication interface 136 and the vehicle interface 124.

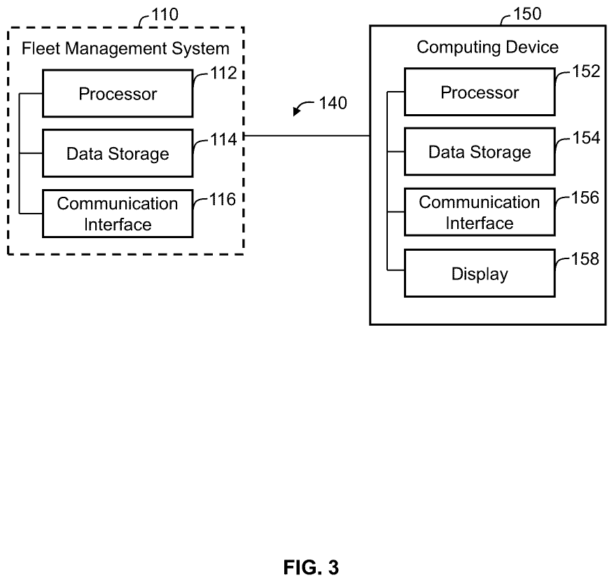

Reference will now be made to FIG. 3 to further explain the operation of the fleet management system 110 and computing devices 150. In the illustrated example, the fleet management system 110 in communication with a computing device 150. As shown, the computing device 150 also can include one or more processors 152, one or more data stores 154, and one or more communication interfaces 156. Additionally, the computing device 150 can include one or more displays 158. Each of these components can communicate with each other. Each of these components may be combined into fewer components or divided into additional subcomponents.

The processors 152 can control the operation of the computing device 150. Like the processors 112 of the fleet management system 110 and the processors 132 of the telematics device 130, the processors 152 of the computing device 150 can be implemented using any suitable processing devices or systems. The processors 152 can execute various computer instructions, programs, and/or software stored on the data stores 154 to implement various methods described herein. For example, the processors 152 may process various telematics data received from the fleet management system 110 and/or the telematics device 130.

The data stores 154 can store various data for the computing device 150. Like the data stores 114 of the fleet management system 110 and the data stores 134 of the telematics device 130, the data stores 154 of the computing device 150 can be implemented using any suitable data storage devices or systems. The data stores 154 can store various computer instructions, programs, and/or software that can be executed by the processor 152 to implement various methods described herein. The data stores 154 may store various telematics data received from the fleet management system 110 and/or the telematics device 130.

The communication interfaces 156 can enable communication between the computing device 150 and other devices or systems, such as the fleet management system 110. Like the communication interfaces 116 of the fleet management system 110 and the communication interfaces 136 of the telematics device 130, the communication interfaces 156 of the computing device 150 can be implemented using any suitable communication devices or systems. The communication interfaces 156 can enable various inputs and outputs to be received at and sent from the computing device 150. For example, the communication interfaces 116 may be used to retrieve telematics data from the fleet management system 110.

The displays 158 can visually present various data for the computing device 150. The displays 158 can be implemented using any suitable display devices or systems, such as, but not limited to, LED (light-emitting diode) displays, LCDs (liquid crystal displays), ELDs (electroluminescent displays), plasma displays, quantum dot displays, and/or cathode ray tube (CRT) displays. The displays 158 can be an integrated component that is integral with the computing device 150 or a standalone device that is removably connected to the computing device 150. The displays 158 can present various user interfaces for various computer applications, programs, and/or software associated with various methods described herein. For example, the displays 158 may display various visual representations of the telematics data.

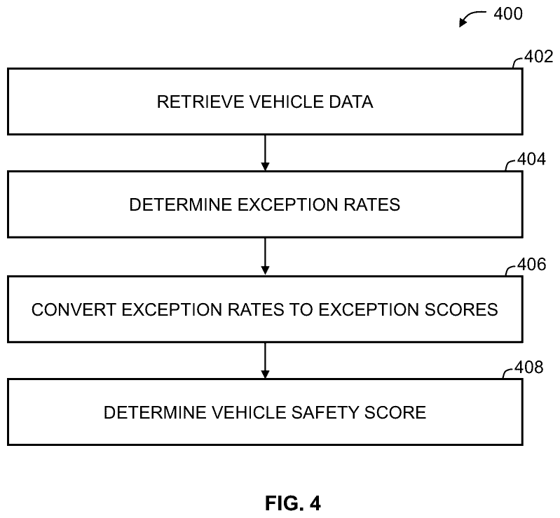

Referring now to FIG. 4, there is shown an example method 400 for generating vehicle safety scores. Each vehicle safety score can represent the relative performance or safety risk of a particular driver and/or vehicle 120. The vehicle safety scores may be used by insurance providers, fleet managers, and other stakeholders to track, evaluate, and improve driver behaviour. The vehicle safety scores can be generated based on telematics data collected from a vehicle 120 by a telematics device 130. The inventors recognized and realized that selectively processing the telematics data could generate vehicle safety scores that effectively represent driver performance and safety risk.

The safety score method 400 can be implemented at the fleet management system 110 (e.g., by at least one processor 112 executing instructions stored on at least one data store 114). An advantage of implementing at least a portion of the safety score method 400 at the fleet management system 110 (i.e., remote from telematics devices 130 and computing devices 150) is that less processing may be executed at the telematics devices 130 and/or computing devices 150. Hence, the hardware complexity and cost of the telematics devices 130 and/or computing devices 150 can be reduced. Furthermore, it may be easier to update and/or modify software running on the fleet management system 110 as compared to the telematics devices 130 and/or computing devices 150. However, it should be appreciated that the safety score method 400 may also be implemented, at least in part, using one or more telematics devices 130, one or more computing devices 150, or a combination thereof in some embodiments. That is, the safety score method 400 may be implemented by any of the one or more processors 112, 132, 152 executing instructions stored on any of the one or more data stores 114, 134, 154.

At 402, vehicle data can be retrieved. The vehicle data can originate from a telematics device 130 installed in a vehicle 120. For example, the vehicle data may be collected by a telematics device via one or more vehicle interfaces 124, such as an ODB-II port and/or CAN bus. The vehicle data may be retrieved from various locations depending on where it is stored. For example, the vehicle data may be retrieved from the fleet management system 110, telematics device 130, and/or computing device 150 (e.g., data stores 114, 134, 154).

The vehicle data can include a plurality of safety exception events performed by the vehicle 120. The safety exception events can represent unsafe or undesirable actions performed by the vehicle 120. For example, each safety exception event can represent an action or activity performed by the vehicle 120 that violates a predetermined safety rule, test, or criterion. The plurality of safety exception events can include a plurality of safety event types. That is, there can be various kinds of safety exception events. For example, the safety exception event types may include harsh events, speeding events, and seatbelt events.

Harsh events can represent occasions where the vehicle 120 exceeded a predetermined acceleration limit. For example, the harsh events can include harsh acceleration events representing excessive positive longitudinal acceleration of the vehicle 120. The harsh events can also include harsh braking events representing excessive negative longitudinal acceleration of the vehicle 120. The harsh events can also include harsh cornering events representing excessive lateral acceleration of the vehicle 120.

Speeding events can represent occasions where the vehicle 120 exceeded a predetermined speed limit. The predetermined speed limit may be based on the legal speed limit of the road on which the vehicle 120 was traveling. For example, the predetermined speed limit may be 110%, 120%, 130%, etc. of the legal speed limit. The speeding events can include different types of speeding events based on the severity of the speeding. For example, the speeding events may include light speeding events, medium speeding events, and heavy speeding events. Each type of speeding event may have a different predetermined speed limit. The predetermined speed limit may depend on the speed of the vehicle 120. For instance, the predetermined speed limit may be a lower percentage at lower speed limits as compared to higher speed limits.

Seatbelt events can represent occasions where the seatbelt of the driver was not buckled during operation of the vehicle 120.

The vehicle data can include various data associated with each safety exception event. For example, for harsh events, the vehicle data may include the duration, time of occurrence, and magnitude of the acceleration of the vehicle 120. Likewise, for speeding events, the vehicle data may include the duration, time of occurrence, and magnitude of the speed of the vehicle 120. Similarly, for seatbelt events, the vehicle data may include the duration and time of occurrence of the seatbelt being buckled and/or unbuckled.

The vehicle data may originate from various electronic sources in the vehicle 120 and/or telematics device 130. For example, acceleration data may originate an accelerometer of the telematics device 130 or may be derived from location data generated by a GPS receiver of the telematics device 130. Likewise, speed data may originate from a speed sensor of the vehicle 120 or may be derived from location data generated by a GPS receiver of the telematics device 130. Similarly, seatbelt data may originate from a seatbelt sensor of the vehicle 120. Regardless, it should be appreciated that the vehicle data is a form of electronic data that requires a computer to transmit, receive, interpret, process and/or store.

At 404, a plurality of exception rates can be determined based on the vehicle data. For example, the exception rates can include harsh event rates, speeding event rates, and seatbelt event rates. Each exception rate can represent a normalized rate of occurrence of one of the exception event types. Each safety exception event can be normalized with respect to distance traveled by the vehicle 120, driving duration, or another operational measure of the vehicle 120 to determine the exception rates.

The harsh event rates can represent a normalized rate of occurrence of harsh events. For example, the harsh event rates can represent the number of harsh events per distance traveled, per driving duration, etc. The harsh event rates can include a harsh acceleration rate, a harsh braking rate, and a harsh cornering rate. In some cases, the harsh events can include harsh event magnitudes, and the harsh event rates can include harsh event magnitude rates. A harsh event magnitude rate can represent a normalized sum of harsh event magnitudes. The harsh event magnitude rates can include a harsh acceleration magnitude rate, a harsh braking magnitude rate, and a harsh cornering magnitude rate.

The speeding event rates can represent a normalized rate of occurrence of speeding events. For example, the speeding event rates can represent the number of speeding events per distance traveled, per driving duration, etc. The speeding event rates may be rescaled based on the severity and/or duration of the speeding. The speeding event rates can include different types of speeding events rates based on the different types of speeding events. For example, the speeding event rates may include light speeding event rates, medium speeding event rates, and heavy speeding event rates. In some cases, the different types of speeding event rates can be combined to generate an overall speeding rate. For example, the overall speeding rate can be determined based on a weighted average of the light speeding event rate, medium speeding event rate, and heavy speeding event rate. The different speeding event rates may be assigned different weights depending on the severity of the speeding event. For instance, light speeding may be assigned a lower weight compared to heavy speeding.

The seatbelt events rates can represent a normalized rate of occurrence of seatbelt events. For example, the seatbelt event rates can represent the number of seatbelt events per distance traveled, per driving duration, etc.

At 306, the plurality of exception rates can be converted into a plurality of exception scores. For example, the exception scores can include a harsh event score, a speeding event score, and a seatbelt event score. The harsh event score may include a harsh acceleration score, harsh braking score, harsh cornering score, harsh acceleration magnitude score, harsh braking magnitude score, and harsh cornering magnitude score.

The exception scores can be generated by converting each exception rate using a plurality of statistical transformation functions such that each exception score satisfies a predetermined statistical distribution. The predetermined statistical distribution can be any statistical distribution. In some embodiments, the predetermined statistical distribution may be a normal or Gaussian distribution.

The statistical transformation functions can alter various statistical properties of the exception rates to produce the exception scores and achieve the desired statistical distribution. This may involve modifying the center, dispersion, and/or shape of the exception rates. For example, the statistical transformation functions may modify the mean, standard deviation, and/or range of the exception rates. Various statistical transformation functions can be employed.

Prior to transformation, exception rates can have different statistical distributions that may be difficult to interpret or compare. For example, some exception rates may exhibit a long-tail distribution. That is, the distribution may include occurrences that are far away from the head or central part of the distribution. These long-tailed distributions may not be well-suited to interpret or compare because of the distribution can contain large differences in value between different portions of the distribution. As well, there can be many similar values near the head or central part of the distribution.

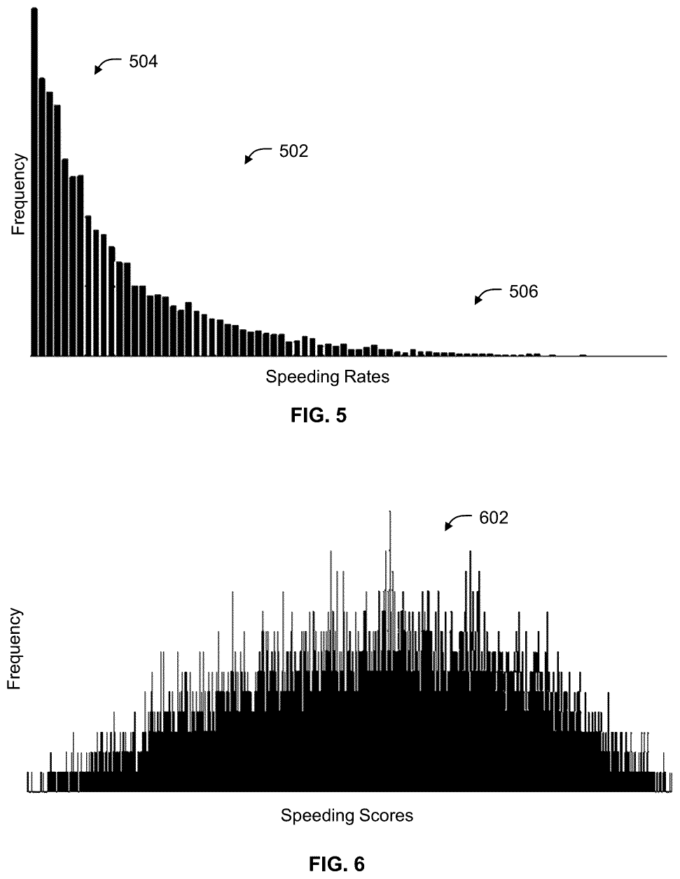

Referring now to FIGS. 5 and 6 there is shown an example distribution of speeding exception rates 502 and speeding event scores 602. As shown, the speeding exception rates 502 exhibit a long-tailed distribution, whereas the speeding event scores 602 exhibit a normal or Gaussian distribution. The speeding exception rates 502 may be difficult to interpret or compare because of the large number of small values at the head 504 of the distribution, as well as the few large values at the tail 506 of the distribution. In the illustrated example, various statistical transformation functions have been applied to the speeding exception rates 502 to transform them into the speeding event scores 602. As shown, the speeding event scores 602 are more evenly distributed and have fewer extreme values, allowing them to be more easily interpreted and compared.

Various statistical transformation functions can be used to convert the exception rates into exception scores. However, the inventors recognized and realized that a sigmoid statistical transformation function and inverse transformation function may be particularly effective at transforming exception rates into a desired statistical distribution.

In some embodiments, the statistical transformation functions can include a sigmoid transformation function. The sigmoid transformation function can be operable to transform each exception rate to satisfy predetermined upper and lower bounds. That is, the sigmoid transformation function can convert the exception rates into a predetermined finite range. For example, the sigmoid transformation function can be defined using the following equation:

$$S ( x ) = 2 \times ( \frac{1}{1 + {e}^{- px}} - 0.5 )$$

where p is an adjustable parameter with a value between 0 and 1.

The adjustable parameter (p) can be determined in various ways. In some embodiments, the adjustable parameter (p) can be determined by performing an optimization based on the desired statistical distribution. For example, an objective function based on the desired range can be minimized (or maximized) to determine the adjustable parameter (p). That is, the range for different values of the adjustable parameter (p) can be calculated, and the adjustable parameter (p) that results in range that is closest to the desired statistical distribution can be selected as the adjustable parameter (p).

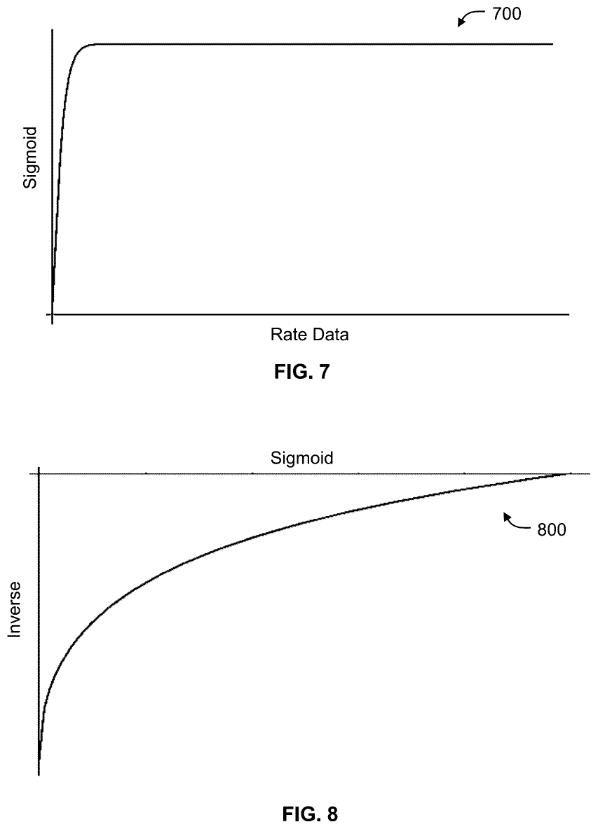

Referring now to FIG. 7, there is shown an example sigmoid transformation function 700 where the adjustable parameter (p) is set to 0.8. As shown, various exception rate data can be input to sigmoid transformation function 700. The sigmoid transformation function 700 can transform data having an infinite range into a predefined finite range. For example, the sigmoid transformation function may transform a distribution of exception rates having a range of 0 to infinity to a range of 0 to 1.

In some embodiments, the plurality of statistical transformation functions can include an inverse transformation function. The inverse transformation function can be operable to transform each exception rate to satisfy a predetermined normal distribution. That is, the inverse transformation function can covert the exception rates into a normal or Gaussian distribution having a predetermined mean and standard deviation. The inverse transformation function can be performed on data that has already been transformed by the sigmoid transformation function (i.e., that satisfies a predetermined range). For example, the inverse transformation function can be defined using the following equation:

$$I ( x ) = \frac{- 1}{0.5 {x}^{p} + 0.5} + 1$$

where p is an adjustable parameter with a value between 0 and 1, which may or may not be same value as the sigmoid transformation function.

The adjustable parameter (p) can be determined in various ways. In some embodiments, the adjustable parameter (p) can be determined by performing an optimization based on the desired statistical distribution. For example, an objective function based on the desired mean and standard deviation can be minimized (or maximized) to determine the adjustable parameter (p). That is, the mean and standard deviation for different values of the adjustable parameter (p) can be calculated, and the adjustable parameter (p) that results in the mean and standard deviation that is closest to the desired statistical distribution can be selected as the adjustable parameter (p).

Referring now to FIG. 8, there is shown an example inverse transformation function 800 where the adjustable parameter (p) is set to 0.5. As shown, exception rate data that has been transformed by the sigmoid transformation function 700 can be input to inverse transformation function 800. The inverse transformation function 800 can transform data having a long-tailed distribution into a normal or Gaussian distribution. For example, the inverse transformation function can transform a distribution of exception rates to a normal distribution having a particular mean and standard deviation.

Referring back to FIG. 4, at 408, a vehicle safety score can be determined. The vehicle safety score can be determined based on each of the exception scores. For example, the vehicle safety score can be determined based on the harsh event score (i.e., the harsh acceleration score, the harsh braking score, the harsh cornering score, the harsh acceleration magnitude score, the harsh braking magnitude score, and the harsh cornering magnitude score), the speeding event score, and the seatbelt event score. The vehicle safety score can represent the risk of the vehicle 120 performing a safety exception event. That is, the vehicle safety score can represent a risk of the vehicle 120 harshly accelerating, harshly braking, harshly cornering, speeding, seatbelt not engaged, etc. In other words, the vehicle safety score can represent the risk of the vehicle 120 performing various unsafe actions. In this manner, the vehicle safety score may be used to assess the safety risk or performance of the vehicle 120 or the driver of the vehicle 120.

The vehicle safety score can be determined in various ways. In some embodiments, the vehicle safety score can be determined based on a weighted average of the exception scores. The different exception scores may be assigned different weights depending on the severity of the safety risk of the underlying safety exception event. For instance, the speeding event score may be assigned a greater weight compared to the seatbelt event score. As another example, the harsh breaking event score and harsh breaking magnitude score may be assigned a greater weight as compared to the harsh acceleration event score, harsh acceleration magnitude score, harsh cornering event score, harsh cornering magnitude score, and seatbelt event score.

The vehicle safety scores can be used in various ways. For example, insurance providers, fleet managers, and other stakeholders may the vehicle safety scores to track, evaluate, and improve driver behaviour. In some cases, the vehicle safety scores may be used to compare different vehicles 120 and fleets of vehicles 120 and determine various benchmarks to assess their relative safety risk or performance.

In some embodiments, the vehicle safety scores can be used to determine a vehicle safety score benchmark. The vehicle safety score benchmark can represent a relative measure of the safety risk (e.g., likelihood of a vehicle 120 to perform a safety exception event) of a vehicle 120 as compared to other comparable vehicles 120. For example, the vehicle safety score benchmark may represent a safety ranking (e.g., absolute or percentile) of various comparable vehicles 120. The vehicle safety score benchmark can be determined based on the vehicle safety score for the vehicle 120 and a plurality of vehicle safety scores for a plurality of comparable vehicles. The plurality of comparable vehicles can include various vehicles 120 that are comparable, similar, alike, or share at least one common characteristic as the vehicle 120.

The comparable vehicles 120 can be identified by clustering or comparing vehicles 120 based on various properties of the vehicles 120. However, not all algorithms may be suitable for determining the comparable vehicles 120 at scale. It may be too resource and/or time intensive to cluster large numbers of vehicles 120. For example, using a k-nearest neighbors algorithm to identify the nearest thousand neighbors for more than a million vehicles 120 may not be practical. The inventors recognized and realized that a combination of clustering and comparison algorithms could be used to improve clustering efficiency and performance.

In various embodiments, a clustering algorithm can be used to identify a plurality of first vehicle clusters. A comparison algorithm can then be used to identify a plurality of second vehicle clusters based on the centroid of each first vehicle cluster. By using the centroids of the first vehicle clusters identified by the clustering algorithm, the computational effort required to perform the comparison algorithm can be greatly reduced. For example, the clustering algorithm can be a k-means algorithm and the comparison algorithm can be a k-nearest neighbors algorithm. By first using the k-means algorithm to identify centroids, the k-nearest neighbors algorithm can then be applied on the centroids, rather than all of the vehicles 120.

However, it should be appreciated that the clustering algorithm can be any suitable clustering algorithms, such as, but not limited to, centroid-based clustering, density-based clustering, distribution-based clustering, and/or hierarchical clustering. For example, the clustering algorithms may include k-means, k-nearest neighbors, affinity propagation, agglomerative clustering, BIRCH, DBSCAN, OPTICS, spectral clustering, mean shift Gaussian mixture models (expectation maximization), etc. Likewise, the comparison algorithm can be any suitable comparison algorithm.

Various properties (and combinations of properties) of the vehicles 120 can be used to cluster or compare the vehicles 120. For example, the vehicles 120 may be clustered or compared based on their area of operation. For instance, the vehicles 120 may be clustered or compared according to the geographical region (e.g., geohash) in which the vehicle 120 spent the most time during a predetermined period of time. As another example, the vehicles 120 may be clustered or compared based on their vocation. That is, the vehicles 120 may be clustered or compared based on predefined classifications relating to their operational behaviour. For instance, the vocations may include door to door, hub and spoke, local, regional, long distance, etc. As a further example, the vehicles 120 may be clustered or compared based on their make, model, and/or year. As yet another example, the vehicles 120 may be clustered or compared according to a predetermined vehicle type. For instance, the vehicle types may include passenger, multi-purpose vehicle, bus, truck, limo, other, etc.

In some embodiments, the vehicle safety scores can be used to determine a fleet safety score. The fleet safety score can represent a measure of the safety risk (e.g., likelihood of a vehicle 120 in the fleet to perform a safety exception event) of a fleet of vehicles 120. The fleet safety score can be determined based on the vehicle safety score of each vehicle 120 in the fleet.

The fleet safety score can be determined in various ways. In some embodiments, the fleet safety score can be determined as an average of the vehicle safety scores of the vehicles 120 in the fleet. In some cases, the average may be a weighted average, with different vehicles 120 being assigned different weights. For example, the weights may be assigned based on the vehicle type, area of operation, vocation, etc.

In some embodiments, the fleet safety score can be used to determine a fleet safety score benchmark. The fleet safety score benchmark can represent a relative measure of the safety risk (e.g., likelihood of a vehicle 120 in the fleet to perform a safety exception event) of a fleet as compared to other comparable fleets. For example, the fleet safety score benchmark may represent a safety ranking (e.g., absolute or percentile) of various comparable fleets. The fleet safety score benchmark can be determined based on the fleet safety score for the fleet and a plurality of fleet safety scores for a plurality of comparable fleets. The plurality of comparable fleets can include various fleets that are comparable, similar, alike, or share at least one common characteristic as the fleet.

The comparable fleets can be identified by clustering fleets based on various properties of the fleets and/or properties of the vehicles 120 in the fleets. For example, the fleets may be clustered based on vocation, vehicle type, area of operation, etc. In some embodiments, the comparable fleets can be identified from a plurality of fleets by using a clustering algorithm to identify a plurality of fleet clusters based on a vehicle type of each vehicle 120 in each fleet in the plurality of fleets. The fleet cluster containing the fleet can be identified as the plurality of comparable fleets.

Various types of clustering algorithms can used to cluster the fleets. In some embodiments, a k-means algorithm can be used to cluster the fleets. It should be appreciated that any suitable clustering algorithm can be used to cluster the fleets, such as, but not limited to, centroid-based clustering, density-based clustering, distribution-based clustering, and/or hierarchical clustering. For example, the clustering algorithm may include k-means, k-nearest neighbors, affinity propagation, agglomerative clustering, BIRCH, DBSCAN, OPTICS, spectral clustering, mean shift Gaussian mixture models (expectation maximization), etc.

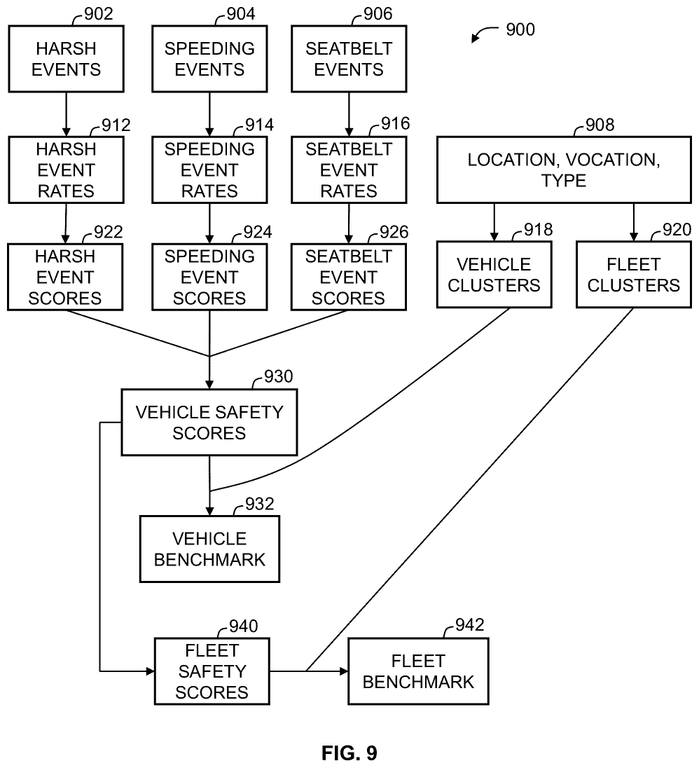

Referring now to FIG. 9, there is shown an example calculation of various vehicle safety scores 930, vehicle safety score benchmarks 932, fleet safety scores 940, and fleet safety score benchmarks 942 using safety score method 400.

As shown, various vehicle data 900, including harsh event data 902, speeding event data 904, and seatbelt event data 906 can be retrieved (e.g., at 402). The harsh event data 902, speeding event data 904, and seatbelt event data 906 can be used to determine harsh event rates 912, speeding event rates 914, and seatbelt event rates 916 respectively (e.g., at 404). The harsh event rates 912, speeding event rates 914, and seatbelt event rates 916 can be converted to harsh event scores 922, speeding event scores 924, and seatbelt event scores 926 respectively (e.g., at 406). The harsh event scores 922, speeding event scores 924, and seatbelt event scores 926 can be used to generate vehicle safety scores 930 (e.g., at 408).

The vehicle data 900 can also include various data that can be used to cluster various comparable vehicles 918 and fleets 920. The vehicle clusters 918 and vehicle safety scores 930 can be used to generate vehicle safety score benchmarks 932. Similarly, the fleet clusters 920 and fleet safety scores 940 can be used to generate fleet safety score benchmarks 942.

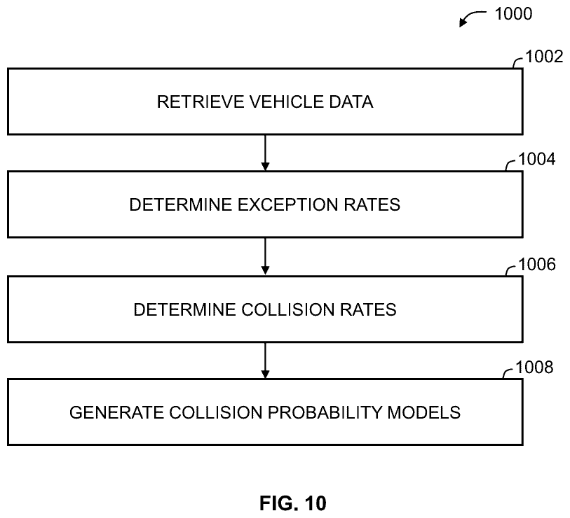

Referring now to FIG. 10, there is shown an example method 1000 for generating or training vehicle collision probability models. The vehicle collision probability models can be used to predict collision probabilities representing the likelihood of a collision for a vehicle 120 and/or driver. The collision probabilities can be used by insurance providers, fleet managers, and other stakeholders to track, evaluate, and improve driver behaviour. The vehicle collision probability models can be generated or trained based on telematics data collected from vehicles 120 by telematics devices 130. The inventors recognized and realized that selectively processing telematics data could generate or train collision probability models that effectively predict collision probabilities.

The collision probability model training method 1000 can be implemented at the fleet management system 110 (e.g., by at least one processor 112 executing instructions stored on at least one data store 114). An advantage of implementing at least a portion of the collision probability model training method 1000 at the fleet management system 110 (i.e., remote from telematics devices 130 and computing devices 150) is that less processing may be executed at the telematics devices 130 and/or computing devices 150. Hence, the hardware complexity and cost of the telematics devices 130 and/or computing devices 150 can be reduced. Furthermore, it may be easier to update and/or modify software running on the fleet management system 110 as compared to the telematics devices 130 and/or computing devices 150. However, it should be appreciated that the collision probability model training method 1000 may also be implemented, at least in part, using one or more telematics devices 130, one or more computing devices 150, or a combination thereof in some embodiments. That is, the collision probability model training method 1000 may be implemented by any of the one or more processors 112, 132, 152 executing instructions stored on any of the one or more data stores 114, 134, 154.

At 1002, vehicle data can be retrieved. The vehicle data can originate from a plurality of telematics devices 130 installed in a plurality of vehicles 120. For example, the vehicle data may be collected by the telematics devices 130 via the vehicle interfaces 124, such as, for example, ODB-II ports and/or CAN busses of the vehicles 120. The vehicle data may be retrieved from various locations depending on where it is stored. For example, the vehicle data may be retrieved from the fleet management system 110, telematics devices 130, and/or computing devices 150 (e.g., data stores 114, 134, 154).

The vehicle data can include a plurality of safety exception events performed by the plurality of vehicles 120. The safety exception events can represent unsafe or undesirable actions performed by the vehicles 120. For example, each safety exception event can represent an action or activity performed by the vehicles 120 that violate a predetermined safety rule, test, or criterion. The plurality of safety exception events can include a plurality of safety event types. That is, there can be various kinds of safety exception events. For example, the safety exception event types may include harsh events and speeding events. As explained herein, the harsh events can correspond to the vehicle 120 undergoing excessive acceleration and include harsh acceleration events, harsh braking events, and harsh cornering events. Similarly, the speeding events can correspond to the vehicle 120 undergoing excessive velocity and include light speeding events, medium speeding events, and heavy speeding events.

The vehicle data can also include a plurality of collision events performed by at least some of the plurality of vehicles 120. The collision events can represent various collisions, crashes, or accidents experienced by the vehicles 120. For example, the collision events may represent the vehicles 120 colliding with another vehicle, pedestrian, animal, road debris, or other moving or stationary obstruction.

The vehicle data can include various data associated with each safety exception event and collision event. For example, for harsh events, the vehicle data may include the duration, time of occurrence, and magnitude of the acceleration of the vehicle 120. Likewise, for speeding events, the vehicle data may include the duration, time of occurrence, and magnitude of the speed of the vehicle 120. Similarly, for collision events, the vehicle data may include the duration, time of occurrence, and severity of the collision.

The vehicle data may originate from various electronic sources in the vehicles 120 and/or telematics device 130. For example, acceleration data may originate accelerometers of the telematics devices 130 or may be derived from location data generated by GPS receivers of the telematics devices 130. Likewise, speed data may originate from speed sensors of the vehicles 120 or may be derived from location data generated by GPS receivers of the telematics devices 130. Similarly, the collision data may originate from accelerometers of the telematics devices 130 or the vehicles 120. Regardless, it should be appreciated that the vehicle data is a form of electronic data that requires a computer to transmit, receive, interpret, process and/or store.

At 1004, a plurality of exception rates can be determined based on the vehicle data. For example, the exception rates can include harsh event rates and speeding event rates. Each exception rate can represent a normalized rate of occurrence of one of the exception event types. The safety exception events can be normalized with respect to distance traveled by the vehicle 120, driving duration, or another operational measure of the vehicle 120 to determine the exception rates.

The harsh event rates can represent a normalized rate of occurrence of harsh events. For example, the harsh event rates can represent the number of harsh events per distance traveled, per driving duration, etc. The harsh event rates can include a harsh acceleration rate, a harsh braking rate, and a harsh cornering rate. In some cases, the harsh events can include harsh event magnitudes, and the harsh event rates can include harsh event magnitude rates. A harsh event magnitude rate can represent a normalized sum of harsh event magnitudes. The harsh event magnitude rates can include a harsh acceleration magnitude rate, a harsh braking magnitude rate, and a harsh cornering magnitude rate.

The speeding event rates can represent a normalized rate of occurrence of speeding events. For example, the speeding event rates can represent the number of speeding events per distance traveled, per driving duration, etc. The speeding event rates may be rescaled based on the severity and/or duration of the speeding. The speeding event rates can include different types of speeding events rates based on the different types of speeding events. For example, the speeding event rates may include light speeding event rates, medium speeding event rates, and heavy speeding event rates. In some cases, the different types of speeding event rates can be combined to generate an overall speeding rate. For example, the overall speeding rate can be determined based on a weighted average of the light speeding event rate, medium speeding event rate, and heavy speeding event rate. The different speeding event rates may be assigned different weights depending on the severity of the speeding event. For instance, light speeding may be assigned a lower weight compared to heavy speeding.

At 1006, a plurality of collision rates can be determined for each exception event type based on the vehicle data and the plurality of exception rates. Each collision rate can represent a normalized rate of occurrence of collision events for a given exception rate. The collision events can be normalized with respect to distance traveled by the vehicles 120, driving duration, or another operational measure of the vehicles 120 to determine the collision rates.

In some embodiments, determining the pluralities of collision rates may involve determining a plurality of data buckets for each exception event type based on the plurality of exception rates. Each data bucket can represent a bin, interval, or range of exception rate values. In some cases, the data buckets can correspond to quantiles of an exception rate, such as quartiles, deciles, or percentiles. However, the data buckets can generally be any size or range. A collision rate can be determined for each data bucket. Hence, each collision rate can correspond to a range of exception rates for a given exception event type.

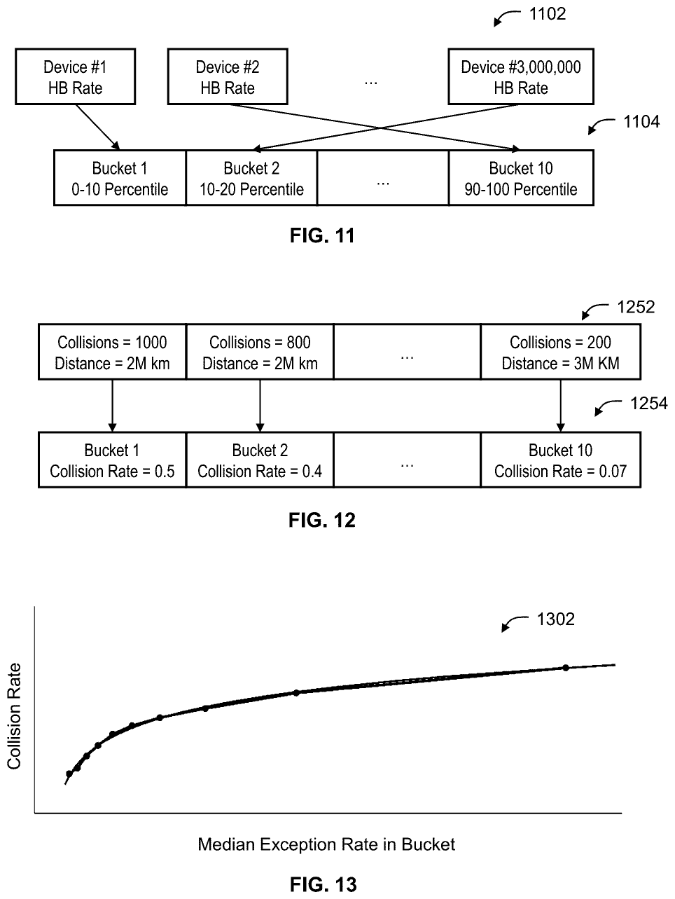

Reference will now be made to FIGS. 11 and 12, which illustrates an example data buckets 1104 and collision rates 1254 for one exception event type. In the illustrated example, the data buckets 1104 correspond to deciles of harsh braking rates 1102. As shown, the data buckets 1104 can be determined based on the distribution of the harsh braking rates 1102. Each harsh braking rate 1102 can correspond to a particular vehicle 120 or telematics device 130 and be sorted into one of the data buckets 1104. A collision rate 1254 can be determined for each data bucket 1104 based on vehicle data 1252 corresponding to the data bucket 1104. In the illustrated example, the collision rates 1254 are determined based on the number of collisions and distance traveled by the vehicles 120 within the respective data bucket 1104.

Referring back to FIG. 10, at 1008, a plurality of collision probability models can be generated or trained based on the plurality of collision rates and the plurality of exception rates. A collision probability model can be generated for each exception event type, for example, using the corresponding collision rates and exception rates. Each collision probability model can be used to predict a sub-probability of a vehicle collision based on an exception rate of the associated exception event type. Various supervised training techniques can be used to train the collision probability models. For example, the collision rates and exception rates may be curve fit to generate the collision probability models. Various functions may be used to represent the collision probability models. In some embodiments, generating the plurality of collision probability models can involve determining a logarithmic function for each exception event type based on the corresponding collision rates and exception rates. A regression analysis may be employed to determine the logarithmic functions, for example, by minimizing a mean squared error.

Reference will now be made to FIG. 13 which illustrates an example collision probability model 1302 one exception event type. In the illustrated example, the collision probability model is a logarithmic function that best fits the collision rates 1254 and harsh braking rates 1102. In the illustrated example, the collision probability model 1302 can be expressed by the following function:

$$Y = {β}_{0} + log ( {β}_{1} X + 1 ) {β}_{2}$$

where Y is a collision sub-probability, X is an exception rate, and β₀, β₁, and β₃ are scaling factors that can determined by curve fitting collision rates and exception rates.

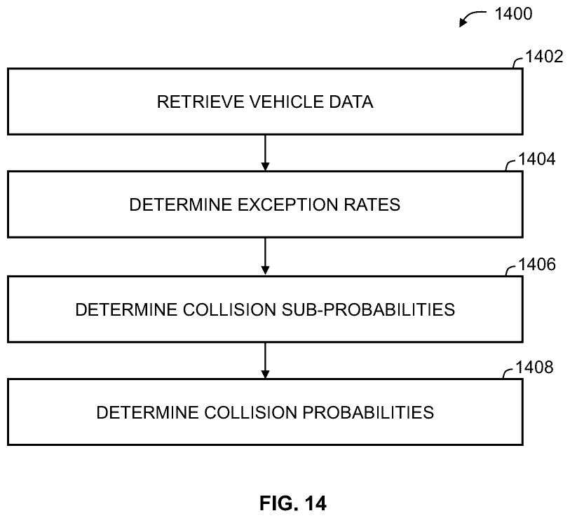

Referring now to FIG. 14, there is shown an example method 1400 for predicting vehicle collision probabilities. A collision probability can represent the risk or likelihood of collision for a given vehicle 120 and/or driver. The collision probabilities can be determined using the collision probability models trained or generated using the collision probability model training method 1000. More specifically, the collision probability models can be used to predict collision sub-probabilities based on exception rates, which can be used to determine collision probabilities. The collision probabilities may be used by insurance providers, fleet managers, and other stakeholders to track, evaluate, and improve driver behaviour. The collision probability models, collision sub-probabilities, and collision probabilities can be generated based on telematics data collected from vehicles 120 by telematics devices 130. The inventors recognized and realized that selectively processing telematics data could generate collision probabilities that effectively predict the risk of collision for a vehicle 120 and/or driver.

The collision probability prediction method 1400 can be implemented at the fleet management system 110 (e.g., by at least one processor 112 executing instructions stored on at least one data store 114). An advantage of implementing at least a portion of the collision probability prediction method 1400 at the fleet management system 110 (i.e., remote from telematics devices 130 and computing devices 150) is that less processing may be executed at the telematics devices 130 and/or computing devices 150. Hence, the hardware complexity and cost of the telematics devices 130 and/or computing devices 150 can be reduced. Furthermore, it may be easier to update and/or modify software running on the fleet management system 110 as compared to the telematics devices 130 and/or computing devices 150. However, it should be appreciated that the collision probability prediction method 1400 may also be implemented, at least in part, using one or more telematics devices 130, one or more computing devices 150, or a combination thereof in some embodiments. That is, the collision probability prediction method 1400 may be implemented by any of the one or more processors 112, 132, 152 executing instructions stored on any of the one or more data stores 114, 134, 154.

At 1402, vehicle data can be retrieved. The vehicle data can originate from a telematics device 130 installed in a vehicle 120. For example, the vehicle data may be collected by the telematics device via one or more vehicle interfaces 124, such an ODB-II port and/or CAN bus. The vehicle data may be retrieved from various locations depending on where it is stored. For example, the vehicle data may be retrieved from the fleet management system 110, telematics device 130, and/or computing device 150 (e.g., data stores 114, 134, 154).

The vehicle data can include a plurality of safety exception events performed by the vehicle 120. The safety exception events can represent unsafe or undesirable actions performed by the vehicle 120. For example, each safety exception event can represent an action or activity performed by the vehicle 120 that violates a predetermined safety rule, test, or criterion. The plurality of safety exception events can include a plurality of safety event types. That is, there can be various kinds of safety exception events. For example, the safety exception event types may include harsh events and speeding events. As explained herein, the harsh events can correspond to the vehicle 120 undergoing excessive acceleration and include harsh acceleration events, harsh braking events, and harsh cornering events. Similarly, the speeding events can correspond to the vehicle 120 undergoing excessive velocity and include light speeding events, medium speeding events, and heavy speeding events.

The vehicle data can include various data associated with each safety exception event. For example, for harsh events, the vehicle data may include the duration, time of occurrence, and magnitude of the acceleration of the vehicle 120. Likewise, for speeding events, the vehicle data may include the duration, time of occurrence, and magnitude of the speed of the vehicle 120.

The vehicle data may originate from various electronic sources in the vehicle 120 and/or telematics device 130. For example, acceleration data may originate an accelerometer of the telematics device 130 or may be derived from location data generated by a GPS receiver of the telematics device 130. Likewise, speed data may originate from a speed sensor of the vehicles 120 or may be derived from location data generated by a GPS receiver of the telematics device 130. Regardless, it should be appreciated that the vehicle data is a form of electronic data that requires a computer to transmit, receive, interpret, process and/or store.

It should be appreciated that the vehicle data used by the collision probability prediction method 1400 can be distinct from the vehicle data used by the collision probability model training method 1000. That is, different vehicle data may be used to train the collision probability models versus determine the collision probabilities. For example, first vehicle data (e.g., originating from a plurality of vehicles 120) can be used by method 1000 to train or generate a plurality of collision probability models and second vehicle data (e.g., originating from a vehicle 120 not in the plurality of vehicles 120) can be used to determine a collision probability for the vehicle 120.

At 1404, a plurality of exception rates can be determined based on the vehicle data. For example, the exception rates can include harsh event rates and speeding event rates. Each exception rate can represent a normalized rate of occurrence of one of the exception event types. The safety exception events can be normalized with respect to distance traveled by the vehicle 120, driving duration, or another operational measure of the vehicle 120 to determine the exception rates.

The harsh event rates can represent a normalized rate of occurrence of harsh events. For example, the harsh event rates can represent the number of harsh events per distance traveled, per driving duration, etc. The harsh event rates can include a harsh acceleration rate, a harsh braking rate, and a harsh cornering rate. In some cases, the harsh events can include harsh event magnitudes, and the harsh event rates can include harsh event magnitude rates. A harsh event magnitude rate can represent a normalized sum of harsh event magnitudes. The harsh event magnitude rates can include a harsh acceleration magnitude rate, a harsh braking magnitude rate, and a harsh cornering magnitude rate.

The speeding event rates can represent a normalized rate of occurrence of speeding events. For example, the speeding event rates can represent the number of speeding events per distance traveled, per driving duration, etc. The speeding event rates may be rescaled based on the severity and/or duration of the speeding. The speeding event rates can include different types of speeding events rates based on the different types of speeding events. For example, the speeding event rates may include light speeding event rates, medium speeding event rates, and heavy speeding event rates. In some cases, the different types of speeding event rates can be combined to generate an overall speeding rate. For example, the overall speeding rate can be determined based on a weighted average of the light speeding event rate, medium speeding event rate, and heavy speeding event rate. The different speeding event rates may be assigned different weights depending on the severity of the speeding event. For instance, light speeding may be assigned a lower weight compared to heavy speeding.

At 1406, a plurality of collision sub-probabilities can be determined using a plurality of collision probability models and the plurality of exception rates. The collision probability models can be mathematical models that have been trained to predict collision sub-probabilities based on exception rates using the collision probability model training method 1000 (i.e., based on collision rates and exception rates for a plurality of vehicles). As described herein, the collision probability models may be logarithmic models. Each collision probability model can be associated with one of the exception event types. For example, the collision probability models may include a harsh acceleration model, a harsh braking model, a harsh cornering model, a speeding model, etc. Each collision probability model can be used to predict one of the collision sub-probabilities based on the exception rate of the associated exception event type. For example, the harsh acceleration model can be used to predict a collision sub-probability based on the harsh acceleration rate, the harsh braking model can be used to predict a collision sub-probability based on the harsh braking rate, the harsh cornering model can be used to predict a collision sub-probability based on the harsh cornering rate, the speeding model can be used to predict a collision sub-probability based on the speeding rate, etc.

At 1408, a collision probability for the vehicle 120 can be determined. The collision probability can represent a risk of collision for the vehicle 120 and/or driver. For example, the collision probability may be a predicted probability or likelihood of a collision for a predetermined travel distance (e.g., probability of a collision for 100,000 km, 1,000,000 km, etc.). Alternatively, the collision probability may be a predicted expected number of collisions for a predetermined travel distance (e.g., number of collisions per 100,000 km, 1,000,000 km, etc.). As another example, the collision probability may be a predicted probability or likelihood of a collision for a predetermined travel time or duration (e.g., probability of collision for 1000 hours driving, 10,000 hours driving, etc.).

The collision probability can be determined based on the plurality of collision sub-probabilities. The collision sub-probabilities can be combined, consolidated, or processed in various ways to determine the collision probability. In some embodiments, the collision probability can be determined by applying a predetermined weight to each collision sub-probability. In other words, the collision probability can be determined based on a weighted average of the collision sub-probabilities. Various weights can be assigned to the collision sub-probabilities based on the relative risk of the associated exception event type. For example, a collision sub-probability associated with harsh braking may be assigned a larger weight than a collision sub-probability associated with speeding, which may be assigned a larger weight than a collision sub-probability associated with harsh acceleration, which may be assigned a larger weight than a collision sub-probability associated with harsh cornering.

In some embodiments, the collision probability can be adjusted or scaled based on various characteristics of the vehicle 120. For example, the collision probability may be scaled based on the vehicle type or class of the vehicle. For instance, the collision probability for a passenger vehicle may be increased relative to the collision probability for a commercial vehicle, such as a bus, truck, or multi-purpose vehicle. Likewise, the collision probability may be adjusted based on duty, weight rating or classification of the vehicle 120. For example, the collision probability for a heavy-duty vehicle may be increased relative to the collision probability for a medium-duty or light-duty vehicle. The characteristics of the vehicle 120 can be determined in various ways. For example, the characteristics of the vehicle 120 may be determined based on an identifier in the vehicle data.

Collision probabilities for vehicles 120 or drivers predicted by the collision probability prediction method 1400 can be used in various ways. For example, insurance providers, fleet managers, and other stakeholders may use the collision probabilities to track, evaluate, and improve driver behaviour. In some cases, the collision probabilities may be used to compare different vehicles 120 (or drivers) and fleets of vehicles 120 and determine various benchmarks to assess their relative collision risk.

In some embodiments, the collision probabilities can be used to determine a vehicle collision probability benchmark. The vehicle collision probability benchmark can represent a relative measure of the collision risk of a vehicle 120 as compared to other comparable vehicles 120. For example, the vehicle collision probability benchmark may represent a ranking (e.g., absolute or percentile) of various comparable vehicles 120. The vehicle collision probability benchmark can be determined based on the collision probability for the vehicle 120 and a plurality of collision probabilities for a plurality of comparable vehicles. The plurality of comparable vehicles can include various vehicles 120 that are comparable, similar, alike, or share at least one common characteristic as the vehicle 120.

The comparable vehicles 120 can be identified by clustering or comparing vehicles 120 based on various properties of the vehicles 120. However, not all algorithms may be suitable for determining the comparable vehicles 120 at scale. It may be too resource and/or time intensive to cluster large numbers of vehicles 120. For example, using a k-nearest neighbors algorithm to identify the nearest thousand neighbors for more than a million vehicles 120 may not be practical. The inventors recognized and realized that a combination of clustering and comparison algorithms could be used to improve clustering efficiency and performance.

In various embodiments, a clustering algorithm can be used to identify a plurality of first vehicle clusters. A comparison algorithm can then be used to identify a plurality of second vehicle clusters based on the centroid of each first vehicle cluster. By using the centroids of the first vehicle clusters identified by the clustering algorithm, the computational effort required to perform the comparison algorithm can be greatly reduced. For example, the clustering algorithm can be a k-means algorithm and the comparison algorithm can be a k-nearest neighbors algorithm. By first using the k-means algorithm to identify centroids, the k-nearest neighbors algorithm can then be applied on the centroids, rather than all of the vehicles 120.

However, it should be appreciated that the clustering algorithm can be any suitable clustering algorithms, such as, but not limited to, centroid-based clustering, density-based clustering, distribution-based clustering, and/or hierarchical clustering. For example, the clustering algorithms may include k-means, k-nearest neighbors, affinity propagation, agglomerative clustering, BIRCH, DBSCAN, OPTICS, spectral clustering, mean shift Gaussian mixture models (expectation maximization), etc. Likewise, the comparison algorithm can be any suitable comparison algorithm.

Various properties (and combinations of properties) of the vehicles 120 can be used to cluster or compare the vehicles 120. For example, the vehicles 120 may be clustered or compared based on their area of operation. For instance, the vehicles 120 may be clustered or compared according to the geographical region (e.g., geohash) in which the vehicle 120 spent the most time during a predetermined period of time. As another example, the vehicles 120 may be clustered or compared based on their vocation. That is, the vehicles 120 may be clustered or compared based on predefined classifications relating to their operational behaviour. For instance, the vocations may include door to door, hub and spoke, local, regional, long distance, etc. As a further example, the vehicles 120 may be clustered or compared based on their make, model, and/or year. As another example, the vehicles 120 may be clustered or compared according to a predetermined vehicle type. For instance, the vehicle types may include passenger, multi-purpose vehicle, bus, truck, limo, other, etc.

In some embodiments, the vehicle collision probabilities can be used to determine a fleet collision probability. The fleet collision probability can represent a measure of the collision risk of a fleet of vehicles 120 (e.g., likelihood of a vehicle 120 in the fleet to experience a collision or expected number of collisions experienced by the fleet). The fleet collision probability can be determined based on the collision probability of each vehicle 120 in the fleet.

The fleet collision probability can be determined in various ways. In some embodiments, the fleet collision probability can be determined as an average of the collision probabilities of the vehicles 120 in the fleet. In some cases, the average may be a weighted average, with different vehicles 120 being assigned different weights. For example, the weights may be assigned based on the vehicle type, area of operation, vocation, etc.

In some embodiments, the fleet collision probability can be used to determine a fleet collision probability benchmark. The fleet collision probability benchmark can represent a relative measure of the collision risk of a fleet as compared to other comparable fleets. For example, the fleet collision probability benchmark may represent a ranking (e.g., absolute or percentile) of various comparable fleets. The fleet collision probability benchmark can be determined based on the fleet collision probability for the fleet and a plurality of fleet collision probabilities for a plurality of comparable fleets. The plurality of comparable fleets can include various fleets that are comparable, similar, alike, or share at least one common characteristic as the fleet.

The comparable fleets can be identified by clustering fleets based on various properties of the fleets and/or properties of the vehicles 120 in the fleets. For example, the fleets may be clustered based on vocation, vehicle type, area of operation, etc. In some embodiments, the comparable fleets can be identified from a plurality of fleets by using a clustering algorithm to identify a plurality of fleet clusters based on a vehicle type of each vehicle 120 in each fleet in the plurality of fleets. The fleet cluster containing the fleet can be identified as the plurality of comparable fleets.

Various types of clustering algorithms can used to cluster the fleets. In some embodiments, a k-means algorithm can be used to cluster the fleets. It should be appreciated that any suitable clustering algorithm can be used to cluster the fleets, such as, but not limited to, centroid-based clustering, density-based clustering, distribution-based clustering, and/or hierarchical clustering. For example, the clustering algorithm may include k-means, k-nearest neighbors, affinity propagation, agglomerative clustering, BIRCH, DBSCAN, OPTICS, spectral clustering, mean shift Gaussian mixture models (expectation maximization), etc.

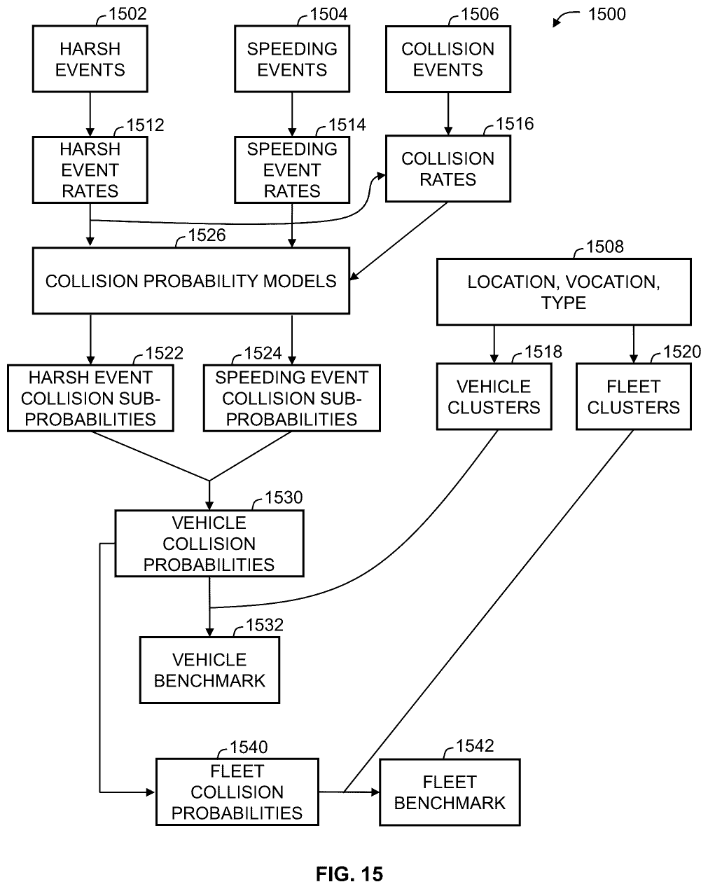

Referring now to FIG. 15, there is shown an example calculation of various collision probability models 1526, vehicle collision probabilities 1530, vehicle collision probability benchmarks 1532, fleet collision probabilities 1540, and fleet collision probability benchmarks 1542 using the collision probability model training method 1000 and collision probability prediction method 1400.

As shown, various vehicle data 1500, including harsh event data 1502, speeding event data 1504, and collision event data 1506, can be retrieved (e.g., at 1002). The harsh event data 1502 and speeding event data 1504 can be used to determine harsh event rates 1512 and speeding event rates 1514 respectively (e.g., at 1004). The harsh event rates 1512, speeding event rates 1514, and collision event data 1506 can be used to determine collision rates 1516 (e.g., at 1006). The harsh event rates 1512, speeding event rates 1514, and collision rates 1516 can be used to train or generate a plurality of collision probability models 1526 (e.g., at 1008). Subsequently, vehicle data 1500 from other vehicles 120, including harsh event data 1502 and speeding event data 1504, can be retrieved (e.g., at 1402). The harsh event data 1502 and speeding event data 1504 can be used to determine harsh event rates 1512 and speeding event rates 1514 respectively (e.g., at 1404). The collision probability models 1526 can use the harsh event rates 1512 and speeding event rates 1514 to predict collision sub-probabilities 1522, 1524 (e.g., at 1406). The collision sub-probabilities 1522, 1524 can be used to determine vehicle collision probabilities 1530 (i.e., at 1408). The vehicle collision probabilities 1530 can be used to determine fleet collision probabilities 1540.

The vehicle data 1500 can also include various data that can be used to cluster various comparable vehicles 1518 and fleets 1520. The vehicle clusters 1518 and vehicle collision probabilities 1530 can be used to generate vehicle collision probability benchmarks 1532. Similarly, the fleet clusters 1520 and fleet collision probabilities 1540 can be used to generate fleet collision probability benchmarks 1542.

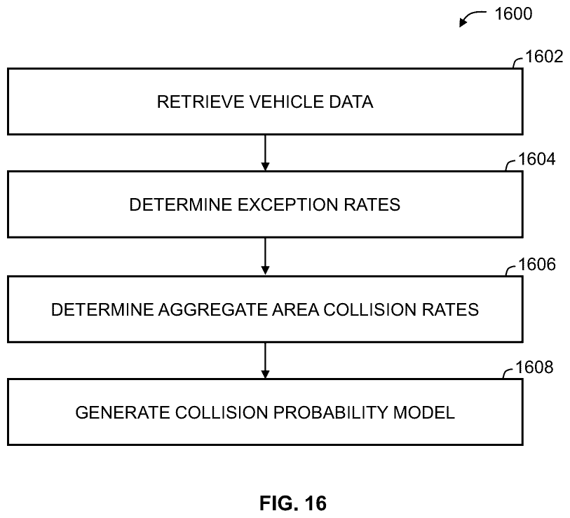

Referring now to FIG. 16, there is shown an example method 1600 for generating or training another vehicle collision probability model. The vehicle collision probability model can be used to predict a collision probability representing the likelihood of a collision for a vehicle 120 and/or driver based on exception and aggregate area collision rates. The collision probabilities can be used by insurance providers, fleet managers, and other stakeholders to track, evaluate, and improve driver behaviour. The vehicle collision probability models can be generated or trained based on telematics data collected from vehicles 120 by telematics devices 130. The inventors recognized and realized that selectively processing telematics data could generate or train collision probability models that effectively predict collision probabilities.

The collision probability model training method 1600 can be implemented at the fleet management system 110 (e.g., by at least one processor 112 executing instructions stored on at least one data store 114). An advantage of implementing at least a portion of the collision probability model training method 1600 at the fleet management system 110 (i.e., remote from telematics devices 130 and computing devices 150) is that less processing may be executed at the telematics devices 130 and/or computing devices 150. Hence, the hardware complexity and cost of the telematics devices 130 and/or computing devices 150 can be reduced. Furthermore, it may be easier to update and/or modify software running on the fleet management system 110 as compared to the telematics devices 130 and/or computing devices 150. However, it should be appreciated that the collision probability model training method 1600 may also be implemented, at least in part, using one or more telematics devices 130, one or more computing devices 150, or a combination thereof in some embodiments. That is, the collision probability model training method 1600 may be implemented by any of the one or more processors 112, 132, 152 executing instructions stored on any of the one or more data stores 114, 134, 154.

At 1602, vehicle data can be retrieved. The vehicle data can originate from a plurality of telematics devices 130 installed in a plurality of vehicles 120. For example, the vehicle data may be collected by the telematics devices 130 via the vehicle interfaces 124, such as, for example, ODB-II ports and/or CAN busses of the vehicles 120. The vehicle data may be retrieved from various locations depending on where it is stored. For example, the vehicle data may be retrieved from the fleet management system 110, telematics devices 130, and/or computing devices 150 (e.g., data stores 114, 134, 154).

The vehicle data can include a plurality of safety exception events performed by the plurality of vehicles 120. The safety exception events can represent unsafe or undesirable actions performed by the vehicles 120. For example, each safety exception event can represent an action or activity performed by the vehicles 120 that violate a predetermined safety rule, test, or criterion. The plurality of safety exception events can include a plurality of safety event types. That is, there can be various kinds of safety exception events. For example, the safety exception event types may include harsh events and speeding events. As explained herein, the harsh events can correspond to the vehicle 120 undergoing excessive acceleration and include harsh acceleration events, harsh braking events, and harsh cornering events. Similarly, the speeding events can correspond to the vehicle 120 undergoing excessive velocity and include light speeding events, medium speeding events, and heavy speeding events.

The vehicle data can also include a plurality of collision events performed by at least some of the plurality of vehicles 120. The collision events can represent various collisions, crashes, or accidents experienced by the vehicles 120. For example, the collision events may represent the vehicles 120 colliding with another vehicle, pedestrian, animal, road debris, or other moving or stationary obstruction.

The vehicle data can include various data associated with each safety exception event and collision event. For example, for harsh events, the vehicle data may include the duration, time of occurrence, and magnitude of the acceleration of the vehicle 120. Likewise, for speeding events, the vehicle data may include the duration, time of occurrence, and magnitude of the speed of the vehicle 120. Similarly, for collision events, the vehicle data may include the duration, time of occurrence, and severity of the collision.

The vehicle data can also include location data representing various locations traveled by the vehicles 120. The location data may include associated time data representing the times at which the vehicle was at the locations.

The vehicle data may originate from various electronic sources in the vehicles 120 and/or telematics device 130. For example, acceleration data may originate accelerometers of the telematics devices 130 or may be derived from location data generated by GPS receivers of the telematics devices 130. Likewise, speed data may originate from speed sensors of the vehicles 120 or may be derived from location data generated by GPS receivers of the telematics devices 130. Similarly, the collision data may originate from accelerometers of the telematics devices 130 or the vehicles 120. Regardless, it should be appreciated that the vehicle data is a form of electronic data that requires a computer to transmit, receive, interpret, process and/or store.

At 1604, a plurality of exception rates can be determined based on the vehicle data. For example, the exception rates can include harsh event rates and speeding event rates. Each exception rate can represent a normalized rate of occurrence of one of the exception event types. The safety exception events can be normalized with respect to distance traveled by the vehicle 120, driving duration, or another operational measure of the vehicle 120 to determine the exception rates.

The harsh event rates can represent a normalized rate of occurrence of harsh events. For example, the harsh event rates can represent the number of harsh events per distance traveled, per driving duration, etc. The harsh event rates can include a harsh acceleration rate, a harsh braking rate, and a harsh cornering rate. In some cases, the harsh events can include harsh event magnitudes, and the harsh event rates can include harsh event magnitude rates. A harsh event magnitude rate can represent a normalized sum of harsh event magnitudes. The harsh event magnitude rates can include a harsh acceleration magnitude rate, a harsh braking magnitude rate, and a harsh cornering magnitude rate.

The speeding event rates can represent a normalized rate of occurrence of speeding events. For example, the speeding event rates can represent the number of speeding events per distance traveled, per driving duration, etc. The speeding event rates may be rescaled based on the severity and/or duration of the speeding. The speeding event rates can include different types of speeding events rates based on the different types of speeding events. For example, the speeding event rates may include light speeding event rates, medium speeding event rates, and heavy speeding event rates. In some cases, the different types of speeding event rates can be combined to generate an overall speeding rate. For example, the overall speeding rate can be determined based on a weighted average of the light speeding event rate, medium speeding event rate, and heavy speeding event rate. The different speeding event rates may be assigned different weights depending on the severity of the speeding event. For instance, light speeding may be assigned a lower weight compared to heavy speeding.

At 1606, a plurality of aggregate area collision rates can be determined based on the vehicle data. Each aggregate area collision rate can represent a collision risk of a vehicle 120 associated with the geographical areas in which the vehicle operates. Each aggregate area collision rate can be determined based on a plurality of area collision rates for a plurality of areas.

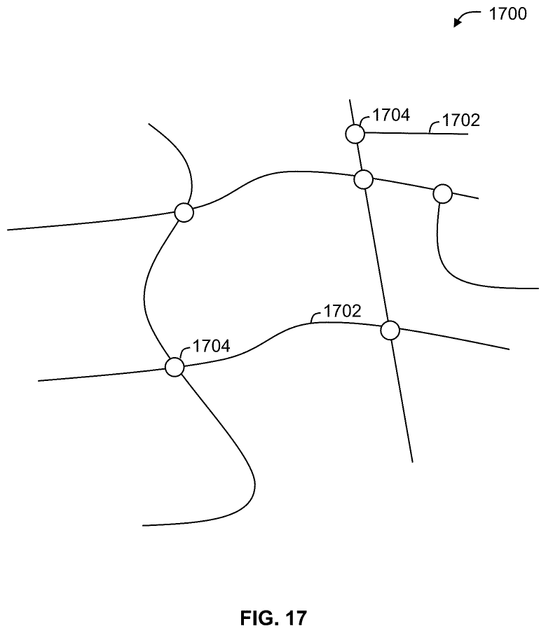

In various embodiments, the areas can include one or more edges of a road network, and the aggregate area collision rates can be determined based on the collision rates for those edges of the road network. For example, FIG. 17 shows an example road network 1700. As shown, the road network includes a plurality of edges 1702 and a plurality of nodes 1704. Each edge 1702 can represent a road and each node 1704 can represent an intersection of roads.

In the illustrated example, each edge 1702 can be associated with an area collision rate representing a likelihood of collision for a vehicle 120 traveling on the edge 1702. Each area collision rate can be determined based on the vehicle data. For example, an area collision rate can be determined for a given edge 1702 based on collision events and other vehicle data from vehicles 120 that traveled on the edge 1702. In some cases, more than one area collision rate can be determined for each area, for example, to account for additional factors, such as direction of travel, time of day, weather, etc.

Continuing with the illustrated example, an aggregate area collision rate can be determined for a vehicle 120 based on the applicable area collision rates for the edges 1702 traveled by the vehicle 120. The area collision rates can be combined in various ways to determine the aggregate area collision rates. For example, the area collision rates can be multiplied together, or summed in log space. As well, different weights can be given to the area collision rates, based on distance traveled, driving duration, or another operational measure of the vehicle 120. In other words, the aggregate area collision rates can also be normalized.

Referring back to FIG. 16, at 1608, a collision probability model can be generated or trained based on the collision event data, the plurality of exception rates, and the plurality of aggregate area collision rates. The collision probability model can be used to predict a probability of a vehicle collision based on the exception rates and aggregate area collision rate for a given vehicle 120 or driver. Put another way, the collision probability model can determine how much to weight each of the exception rates and aggregate area collision rate for a given vehicle or driver to predict their risk of collision.

The collision probability model can be a machine learning model that can be trained using supervised, unsupervised, semi-supervised, reinforcement, or other types of learning. Various models may be used, separately or in combination, such as, but not limited to, artificial neural networks, decision trees, support-vector machines, nearest neighbors, linear regression, logistical regression, Bayesian networks, random forests, genetic algorithms, ensemble models, and the like. In general, the model can be any model that is trained to determine collision probabilities based on exception and aggregate area collision rates, without being explicitly programmed to do so.

In some embodiments, the collision probability model can include a decision tree. Decision trees are a supervised machine learning algorithm that models decisions and their possible consequences as a tree-like structure of nodes. An advantage of using a decision tree is that it can accurately determine collision probabilities using a limited training dataset. The inventors recognized and realized that data pertaining to collisions can be difficult to obtain.

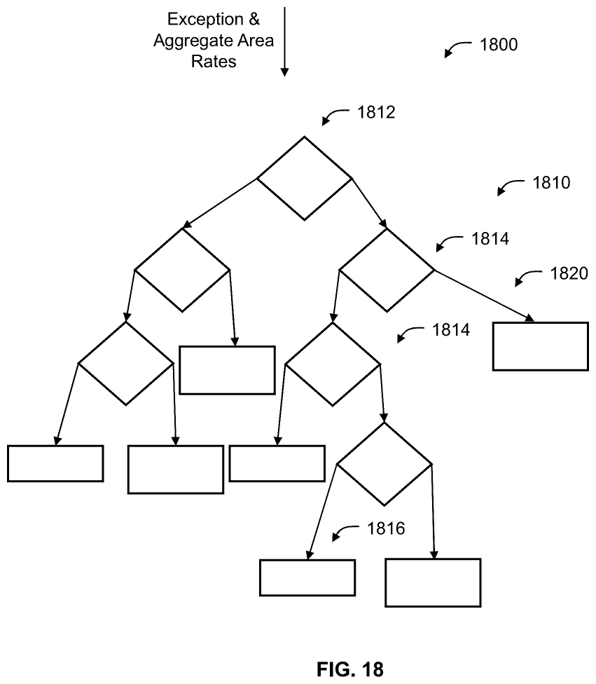

FIG. 18 shows an example decision tree 1800. As shown, the decision tree 1800 can have a hierarchical or tree-like structure made up of a plurality of nodes 1810 and a plurality of branches 1820 connecting the nodes 1810. Each internal or decision node 1814 can represent a decision or test on an attribute, each branch 1820 can represent the outcome of that decision or test, and each end or leaf node 1816 can represent a prediction. As shown, each path from the root node 1812 to a leaf node 1814 can represent a prediction rule. The structure of the decision tree 1800 (e.g., the attributes evaluated at each node) can be established by a suitable training using suitable training data.

In some embodiments, the collision probability model can be a decision tree ensemble. In other words, the collision probability model can include a plurality of decision trees 1800. Using multiple decision trees 1800 in combination can result in better predictive performance as compared to using any constituent decision tree 1800 alone. Examples of decision tree ensemble models may include bagged (or bootstrapped) decision trees, boosted decision trees, and stacked decision trees. However, it should be appreciated that various other types of decision tree ensemble models may be employed.

In some embodiments, the collision probability model can be a gradient boosted decision tree. A gradient boosted decision tree generally involves a sequence of trees 1800, where each tree 1800 attempts to correct the errors made by the previous trees 1800.

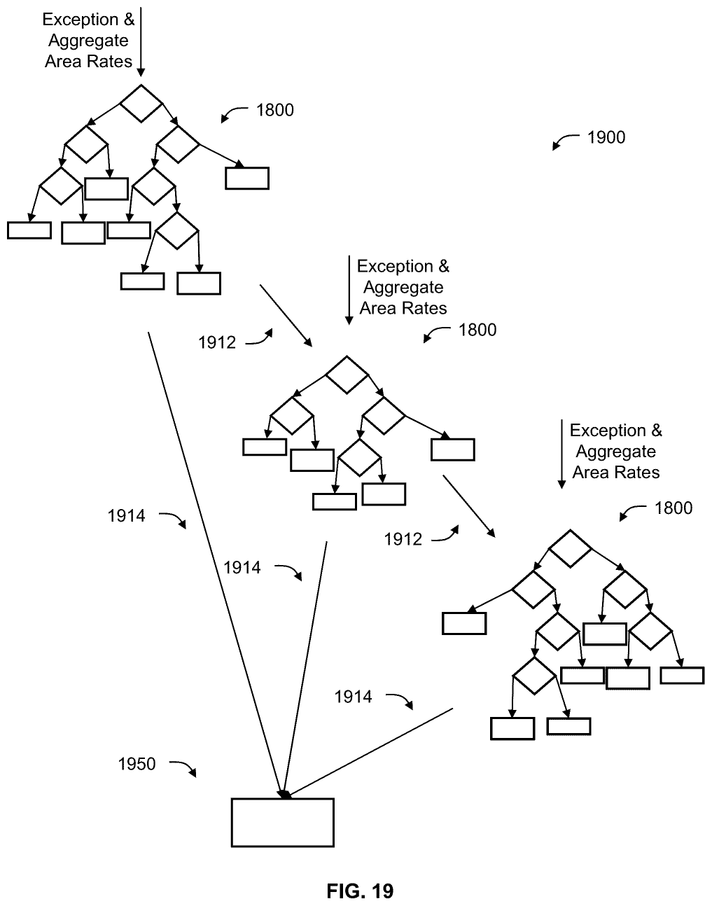

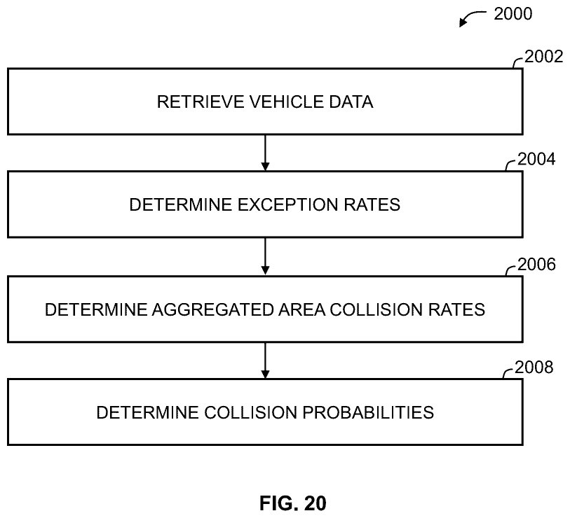

FIG. 19 shows an example gradient boosted decision tree 1900. As shown, the gradient boosted decision tree 1900 includes a plurality of decision trees 1800. The prediction 1914 or output of each decision tree 1800 can be combined to provide an overall prediction or output 1950. Residuals 1912 (differences between observed and estimated values) generated by a given decision tree 1800 can be provided as additional input to the subsequent decision tree 1800. An advantage of using a gradient boosted decision tree is that it can more accurately predict collisions probabilities as compared to a single decision tree, while still using a limited training dataset. As described herein, the inventors recognized and realized that data pertaining to collisions can be difficult to obtain.

Referring now to FIG. 20, there is shown an example method 2000 for predicting vehicle collision probabilities. A collision probability can represent the risk or likelihood of collision for a given vehicle 120 and/or driver. The collision probabilities can be determined using a collision probability model trained or generated using the collision probability model training method 1600. More specifically, the collision probability model can be used to determine collision probabilities based on exception and aggregate area collision rates. The collision probabilities may be used by insurance providers, fleet managers, and other stakeholders to track, evaluate, and improve driver behaviour. The collision probability models and collision probabilities can be generated based on telematics data collected from vehicles 120 by telematics devices 130. The inventors recognized and realized that selectively processing telematics data could generate collision probabilities that effectively predict the risk of collision for a vehicle 120 and/or driver.

The collision probability prediction method 2000 can be implemented at the fleet management system 110 (e.g., by at least one processor 112 executing instructions stored on at least one data store 114). An advantage of implementing at least a portion of the collision probability prediction method 2000 at the fleet management system 110 (i.e., remote from telematics devices 130 and computing devices 150) is that less processing may be executed at the telematics devices 130 and/or computing devices 150. Hence, the hardware complexity and cost of the telematics devices 130 and/or computing devices 150 can be reduced. Furthermore, it may be easier to update and/or modify software running on the fleet management system 110 as compared to the telematics devices 130 and/or computing devices 150. However, it should be appreciated that the collision probability prediction method 2000 may also be implemented, at least in part, using one or more telematics devices 130, one or more computing devices 150, or a combination thereof in some embodiments. That is, the collision probability prediction method 2000 may be implemented by any of the one or more processors 112, 132, 152 executing instructions stored on any of the one or more data stores 114, 134, 154.

At 2002, vehicle data can be retrieved. The vehicle data can originate from a telematics device 130 installed in a vehicle 120. For example, the vehicle data may be collected by the telematics device via one or more vehicle interfaces 124, such an ODB-II port and/or CAN bus. The vehicle data may be retrieved from various locations depending on where it is stored. For example, the vehicle data may be retrieved from the fleet management system 110, telematics device 130, and/or computing device 150 (e.g., data stores 114, 134, 154).

The vehicle data can include a plurality of safety exception events performed by the vehicle 120. The safety exception events can represent unsafe or undesirable actions performed by the vehicle 120. For example, each safety exception event can represent an action or activity performed by the vehicle 120 that violates a predetermined safety rule, test, or criterion. The plurality of safety exception events can include a plurality of safety event types. That is, there can be various kinds of safety exception events. For example, the safety exception event types may include harsh events and speeding events. As explained herein, the harsh events can correspond to the vehicle 120 undergoing excessive acceleration and include harsh acceleration events, harsh braking events, and harsh cornering events. Similarly, the speeding events can correspond to the vehicle 120 undergoing excessive velocity and include light speeding events, medium speeding events, and heavy speeding events.

The vehicle data can include various data associated with each safety exception event. For example, for harsh events, the vehicle data may include the duration, time of occurrence, and magnitude of the acceleration of the vehicle 120. Likewise, for speeding events, the vehicle data may include the duration, time of occurrence, and magnitude of the speed of the vehicle 120.

The vehicle data can also include location data representing various locations traveled by the vehicle 120. The location data may include associated time data representing the times at which the vehicle 120 was at the locations.

The vehicle data may originate from various electronic sources in the vehicle 120 and/or telematics device 130. For example, acceleration data may originate an accelerometer of the telematics device 130 or may be derived from location data generated by a GPS receiver of the telematics device 130. Likewise, speed data may originate from a speed sensor of the vehicles 120 or may be derived from location data generated by a GPS receiver of the telematics device 130. Regardless, it should be appreciated that the vehicle data is a form of electronic data that requires a computer to transmit, receive, interpret, process and/or store.

It should be appreciated that the vehicle data used by the collision probability prediction method 2000 can be distinct from the vehicle data used by the collision probability model training method 1600. That is, different vehicle data may be used to train the collision probability model versus determine the collision probabilities. For example, first vehicle data (e.g., originating from a plurality of vehicles 120) can be used by method 1600 to train or generate a plurality of collision probability models and second vehicle data (e.g., originating from a vehicle 120 not in the plurality of vehicles 120) can be used to determine a collision probability for the vehicle 120 and/or driver.

At 2004, a plurality of exception rates can be determined based on the vehicle data. For example, the exception rates can include harsh event rates and speeding event rates. Each exception rate can represent a normalized rate of occurrence of one of the exception event types. The safety exception events can be normalized with respect to distance traveled by the vehicle 120, driving duration, or another operational measure of the vehicle 120 to determine the exception rates.

The harsh event rates can represent a normalized rate of occurrence of harsh events. For example, the harsh event rates can represent the number of harsh events per distance traveled, per driving duration, etc. The harsh event rates can include a harsh acceleration rate, a harsh braking rate, and a harsh cornering rate. In some cases, the harsh events can include harsh event magnitudes, and the harsh event rates can include harsh event magnitude rates. A harsh event magnitude rate can represent a normalized sum of harsh event magnitudes. The harsh event magnitude rates can include a harsh acceleration magnitude rate, a harsh braking magnitude rate, and a harsh cornering magnitude rate.

The speeding event rates can represent a normalized rate of occurrence of speeding events. For example, the speeding event rates can represent the number of speeding events per distance traveled, per driving duration, etc. The speeding event rates may be rescaled based on the severity and/or duration of the speeding. The speeding event rates can include different types of speeding events rates based on the different types of speeding events. For example, the speeding event rates may include light speeding event rates, medium speeding event rates, and heavy speeding event rates. In some cases, the different types of speeding event rates can be combined to generate an overall speeding rate. For example, the overall speeding rate can be determined based on a weighted average of the light speeding event rate, medium speeding event rate, and heavy speeding event rate. The different speeding event rates may be assigned different weights depending on the severity of the speeding event. For instance, light speeding may be assigned a lower weight compared to heavy speeding.

At 2006, an aggregate area collision rate can be determined based on the vehicle data. As described herein, the aggregate area collision rate can represent a collision risk associated with the geographical areas in which the vehicle 120 operated. The aggregate area collision rate can be determined based on a plurality of area collision rates for a plurality of areas traveled by the vehicle 120.

In various embodiments, location data can be used to identify a plurality of road network edges 1702 traveled by the vehicle 120. The aggregate area collision rate can be determined based on a predetermined area collision rate for each of road network edges 1702. As described herein, the predetermined area collision rates of each road network edge 1702 can be contextually specific, for example, based on direction of travel, time of day, weather, etc. Accordingly, an area collision rate applicable to the vehicle's operation can be selected for each edge 1702 (i.e., over other area collision rates for that edge 1702 relating to other contexts that are not applicable). The area collision rates can be combined in various ways to determine the aggregate area collision rate. For example, the area collision rates can be multiplied together, or summed in log space. As well, different weights can be given to the area collision rates, based on distance traveled, driving duration, or another operational measure of the vehicle 120. In other words, the aggregate area collision rate can also be normalized.

At 2008, a collision probability for the vehicle 120 can be determined. The collision probability can represent a risk of collision for the vehicle 120 and/or driver. For example, the collision probability may be a predicted probability or likelihood of a collision for a predetermined travel distance (e.g., probability of a collision for 100,000 km, 1,000,000 km, etc.). Alternatively, the collision probability may be a predicted expected number of collisions for a predetermined travel distance (e.g., number of collisions per 100,000 km, 1,000,000 km, etc.). As another example, the collision probability may be a predicted probability or likelihood of a collision for a predetermined travel time or duration (e.g., probability of collision for 1000 hours driving, 10,000 hours driving, etc.).

The vehicle collision probability can be determined using a collision probability model on the plurality exception rates and aggregate area collision rate. As described herein, the collision probability model can be a machine learning model that is trained to determine how much to weight the exception rates and aggregate area collision rate to predict a vehicle collision probability. In various embodiments, the collision probability model can include a decision tree, decision tree ensemble, and/or gradient boosted decision tree.

Collision probabilities for vehicles 120 or drivers predicted by the collision probability prediction method 2000 can be used in various ways. For example, insurance providers, fleet managers, and other stakeholders may use the collision probabilities to track, evaluate, and improve driver behaviour. In some cases, the collision probabilities may be used to compare different vehicles 120 (or drivers) and fleets of vehicles 120 and determine various benchmarks to assess their relative collision risk.

In some embodiments, the collision probabilities can be used to determine a vehicle collision probability benchmark. The vehicle collision probability benchmark can represent a relative measure of the collision risk of a vehicle 120 as compared to other comparable vehicles 120. For example, the vehicle collision probability benchmark may represent a ranking (e.g., absolute or percentile) of various comparable vehicles 120. The vehicle collision probability benchmark can be determined based on the collision probability for the vehicle 120 and a plurality of collision probabilities for a plurality of comparable vehicles. The plurality of comparable vehicles can include various vehicles 120 that are comparable, similar, alike, or share at least one common characteristic as the vehicle 120.

The comparable vehicles 120 can be identified by clustering or comparing vehicles 120 based on various properties of the vehicles 120. However, not all algorithms may be suitable for determining the comparable vehicles 120 at scale. It may be too resource and/or time intensive to cluster large numbers of vehicles 120. For example, using a k-nearest neighbors algorithm to identify the nearest thousand neighbors for more than a million vehicles 120 may not be practical. The inventors recognized and realized that a combination of clustering and comparison algorithms could be used to improve clustering efficiency and performance.

In various embodiments, a clustering algorithm can be used to identify a plurality of first vehicle clusters. A comparison algorithm can then be used to identify a plurality of second vehicle clusters based on the centroid of each first vehicle cluster. By using the centroids of the first vehicle clusters identified by the clustering algorithm, the computational effort required to perform the comparison algorithm can be greatly reduced. For example, the clustering algorithm can be a k-means algorithm and the comparison algorithm can be a k-nearest neighbors algorithm. By first using the k-means algorithm to identify centroids, the k-nearest neighbors algorithm can then be applied on the centroids, rather than all of the vehicles 120.

However, it should be appreciated that the clustering algorithm can be any suitable clustering algorithms, such as, but not limited to, centroid-based clustering, density-based clustering, distribution-based clustering, and/or hierarchical clustering. For example, the clustering algorithms may include k-means, k-nearest neighbors, affinity propagation, agglomerative clustering, BIRCH, DBSCAN, OPTICS, spectral clustering, mean shift Gaussian mixture models (expectation maximization), etc. Likewise, the comparison algorithm can be any suitable comparison algorithm.

Various properties (and combinations of properties) of the vehicles 120 can be used to cluster or compare the vehicles 120. For example, the vehicles 120 may be clustered or compared based on their area of operation. For instance, the vehicles 120 may be clustered or compared according to the geographical region (e.g., geohash) in which the vehicle 120 spent the most time during a predetermined period of time. As another example, the vehicles 120 may be clustered or compared based on their vocation. That is, the vehicles 120 may be clustered or compared based on predefined classifications relating to their operational behaviour. For instance, the vocations may include door to door, hub and spoke, local, regional, long distance, etc. As a further example, the vehicles 120 may be clustered or compared based on their make, model, and/or year. As another example, the vehicles 120 may be clustered or compared according to a predetermined vehicle type. For instance, the vehicle types may include passenger, multi-purpose vehicle, bus, truck, limo, other, etc.

In some embodiments, the vehicle collision probabilities can be used to determine a fleet collision probability. The fleet collision probability can represent a measure of the collision risk of a fleet of vehicles 120 (e.g., likelihood of a vehicle 120 in the fleet to experience a collision or expected number of collisions experienced by the fleet). The fleet collision probability can be determined based on the collision probability of each vehicle 120 in the fleet.

The fleet collision probability can be determined in various ways. In some embodiments, the fleet collision probability can be determined as an average of the collision probabilities of the vehicles 120 in the fleet. In some cases, the average may be a weighted average, with different vehicles 120 being assigned different weights. For example, the weights may be assigned based on the vehicle type, area of operation, vocation, etc.

In some embodiments, the fleet collision probability can be used to determine a fleet collision probability benchmark. The fleet collision probability benchmark can represent a relative measure of the collision risk of a fleet as compared to other comparable fleets. For example, the fleet collision probability benchmark may represent a ranking (e.g., absolute or percentile) of various comparable fleets. The fleet collision probability benchmark can be determined based on the fleet collision probability for the fleet and a plurality of fleet collision probabilities for a plurality of comparable fleets. The plurality of comparable fleets can include various fleets that are comparable, similar, alike, or share at least one common characteristic as the fleet.

The comparable fleets can be identified by clustering fleets based on various properties of the fleets and/or properties of the vehicles 120 in the fleets. For example, the fleets may be clustered based on vocation, vehicle type, area of operation, etc. In some embodiments, the comparable fleets can be identified from a plurality of fleets by using a clustering algorithm to identify a plurality of fleet clusters based on a vehicle type of each vehicle 120 in each fleet in the plurality of fleets. The fleet cluster containing the fleet can be identified as the plurality of comparable fleets.

Various types of clustering algorithms can used to cluster the fleets. In some embodiments, a k-means algorithm can be used to cluster the fleets. It should be appreciated that any suitable clustering algorithm can be used to cluster the fleets, such as, but not limited to, centroid-based clustering, density-based clustering, distribution-based clustering, and/or hierarchical clustering. For example, the clustering algorithm may include k-means, k-nearest neighbors, affinity propagation, agglomerative clustering, BIRCH, DBSCAN, OPTICS, spectral clustering, mean shift Gaussian mixture models (expectation maximization), etc.

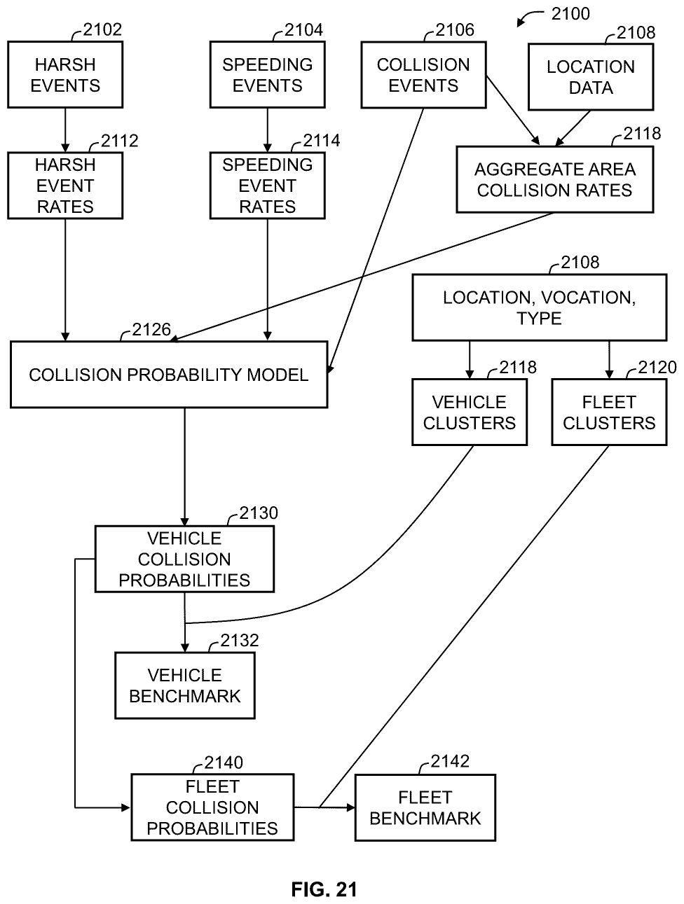

Referring now to FIG. 21, there is shown an example calculation of various collision probability models 2126, vehicle collision probabilities 2130, vehicle collision probability benchmarks 2132, fleet collision probabilities 2140, and fleet collision probability benchmarks 2142 using the collision probability model training method 1600 and collision probability prediction method 2100.

As shown, various vehicle data 2100, including harsh event data 2102, speeding event data 2104, collision event data 2106, and location data 2108 can be retrieved (e.g., at 1602). The harsh event data 2102 and speeding event data 2104 can be used to determine harsh event rates 2112 and speeding event rates 2114 respectively (e.g., at 1604). The collision event data 2006 and location data 2108 can be used to determine area collision rates and aggregate area collision rates 2118 (e.g., at 1606). The harsh event rates 2112, speeding event rates 2114, aggregate area collision rates 2116, and collision event data 2106, can be used to train or generate a collision probability model 2126 (e.g., at 1608). Subsequently, vehicle data 2100 from other vehicles 120, including harsh event data 2102, speeding event data 2104, and location data 2108, can be retrieved (e.g., at 2002). The harsh event data 2102 and speeding event data 2104 can be used to determine harsh event rates 2112 and speeding event rates 2114 respectively (e.g., at 2004). The location data 2108 can be used to determine aggregate area collision rates 2118 (e.g., at 2006) The collision probability model 2126 can use the harsh event rates 2012, speeding event rates 2014, and aggregate area collision rates 2118 to predict vehicle collision probabilities 2130 (e.g., at 2008). The vehicle collision probabilities 2130 can be used to determine fleet collision probabilities 2140.

The vehicle data 2100 can also include various data that can be used to cluster various comparable vehicles 2118 and fleets 2120. The vehicle clusters 2118 and vehicle collision probabilities 2130 can be used to generate vehicle collision probability benchmarks 2132. Similarly, the fleet clusters 2120 and fleet collision probabilities 2140 can be used to generate fleet collision probability benchmarks 2142.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. Furthermore, the term “coupled” may indicate that two elements can be directly coupled to one another or coupled to one another through one or more intermediate elements.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Furthermore, any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). Programmable hardware such as FPGA can also be used as standalone or in combination with other devices. These devices may also have at least one input device (e.g., a pushbutton keyboard, mouse, a touchscreen, and the like), and at least one output device (e.g., a display screen, a printer, a wireless radio, and the like) depending on the nature of the device. The devices may also have at least one communication device (e.g., a network interface).

It should also be noted that there may be some elements that are used to implement at least part of one of the embodiments described herein that may be implemented via software that is written in a high-level computer programming language such as object-oriented programming. Accordingly, the program code may be written in C, C++ or any other suitable programming language and may comprise modules or classes, as is known to those skilled in object-oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A system for predicting collision probabilities, the system comprising:
at least one data store operable to store vehicle data originating from a telematics device installed in a vehicle, the vehicle data comprising location data and a plurality of safety exception events performed by the vehicle, the plurality of safety exception events comprising a plurality of exception event types;
at least one processor in communication with the at least one data store, the at least one processor operable to:
retrieve the vehicle data;
identify a plurality of road network edges traveled by the vehicle based on the location data;
determine an aggregated area collision rate based on the plurality of road network edges;
determine a plurality of exception rates based on the vehicle data, each exception rate representing a normalized rate of occurrence of one of the exception event types; and
determine a collision probability using at least one machine learning model on the plurality of exception rates and the aggregated area collision rate, the collision probability representing a risk of collision.

2. The system of claim 1, wherein the at least one machine learning model comprises a decision tree.

3. The system of claim 1, wherein the at least one processor is operable to:
retrieve a plurality of predetermined area collision rates, a predetermined area collision rate retrieved for each road network edge; and
determine the aggregated area collision rate based on the plurality of predetermined area collision rates.

4. The system of claim 1, wherein the at least one processor is operable to:
determine a vehicle collision probability benchmark for the vehicle based on the collision probability and a plurality of collision probabilities for a plurality of comparable vehicles.

5. The system of claim 4, wherein the at least one processor is operable to:
identify the plurality of comparable vehicles from a plurality of vehicles by:
using a clustering algorithm to identify a plurality of first vehicle clusters based on an area of operation of each vehicle in the plurality of vehicles; and
using a comparison algorithm to identify a plurality of second vehicle clusters based on the centroid of each first vehicle cluster; and
identify the second vehicle cluster containing the vehicle as the plurality of comparable vehicles.

6. The system of claim 1, wherein the at least one processor is operable to:
determine a fleet collision probability for a fleet comprising the vehicle based on the collision probability and a vehicle collision probability for each other vehicle in the fleet.

7. The system of claim 6, wherein the at least one processor is operable to:
determine a fleet collision probability benchmark for the fleet based on the fleet collision probability for the fleet and a plurality of fleet collision probabilities for a plurality of comparable fleets.

8. The system of claim 7, wherein the at least one processor is operable to:
identify the plurality of comparable fleets from a plurality of fleets by using a clustering algorithm to identify a plurality of fleet clusters based on a vehicle type of each vehicle in each fleet in the plurality of fleets; and
identify the fleet cluster containing the fleet as the plurality of comparable fleets.

9. The system of claim 1, wherein:
the plurality of exception event types comprises harsh events and speeding events; and
the plurality of exception rates comprises harsh event rates and speeding event rates.

10. A method for predicting collision probabilities, the method comprising operating at least one processor to:
retrieve vehicle data originating from a telematics device installed in a vehicle, the vehicle data comprising location data and a plurality of safety exception events performed by the vehicle, the plurality of safety exception events comprising a plurality of exception event types;
identify a plurality of road network edges traveled by the vehicle based on the location data;
determine an aggregated area collision rate based on the plurality of road network edges;
determine a plurality of exception rates based on the vehicle data, each exception rate representing a normalized rate of occurrence of one of the exception event types; and
determine a collision probability using at least one machine learning model on the plurality of exception rates and the aggregated area collision rate, the collision probability representing a risk of collision.

11. The method of claim 10, wherein the at least one machine learning model comprises a decision tree.

12. The method of claim 10, further comprising operating the at least one processor to:
retrieve a plurality of predetermined area collision rates, a predetermined area collision rate retrieved for each road network edge; and
determine the aggregated area collision rate based on the plurality of predetermined area collision rates.

13. The method of claim 10, further comprising operating the at least one processor to:
determine a vehicle collision probability benchmark for the vehicle based on the collision probability and a plurality of collision probabilities for a plurality of comparable vehicles.

14. The method of claim 13, further comprising operating the at least one processor to:
identify the plurality of comparable vehicles from a plurality of vehicles by:
using a clustering algorithm to identify a plurality of first vehicle clusters based on an area of operation of each vehicle in the plurality of vehicles; and
using a comparison algorithm to identify a plurality of second vehicle clusters based on the centroid of each first vehicle cluster; and
identify the second vehicle cluster containing the vehicle as the plurality of comparable vehicles.

15. The method of claim 10, further comprising operating the at least one processor to:
determine a fleet collision probability for a fleet comprising the vehicle based on the collision probability and a vehicle collision probability for each other vehicle in the fleet.

16. The method of claim 15, further comprising operating the at least one processor to:
determine a fleet collision probability benchmark for the fleet based on the fleet collision probability for the fleet and a plurality of fleet collision probabilities for a plurality of comparable fleets.

17. The method of claim 16, further comprising operating the at least one processor to:
identify the plurality of comparable fleets from a plurality of fleets by using a clustering algorithm to identify a plurality of fleet clusters based on a vehicle type of each vehicle in each fleet in the plurality of fleets; and
identify the fleet cluster containing the fleet as the plurality of comparable fleets.

18. The method of claim 10, wherein:
the plurality of exception event types comprises harsh events and speeding events; and
the plurality of exception rates comprises harsh event rates and speeding event rates.

19. A non-transitory computer readable medium having instructions stored thereon executable by at least one processor to implement a method for predicting collision probabilities, the method comprising operating the at least one processor to:
retrieve vehicle data originating from a telematics device installed in a vehicle, the vehicle data comprising location data and a plurality of safety exception events performed by the vehicle, the plurality of safety exception events comprising a plurality of exception event types;
identify a plurality of road network edges traveled by the vehicle based on the location data;
determine an aggregated area collision rate based on the plurality of road network edges;
determine a plurality of exception rates based on the vehicle data, each exception rate representing a normalized rate of occurrence of one of the exception event types;
determine a collision probability using at least one machine learning model on the plurality of exception rates and the aggregated area collision rate, the collision probability representing a risk of collision.
